(19) United States
(12) Patent Application Publication
(10) Pub. No.: US 2003/0055664 A1
(43) Pub. Date: Mar. 20, 2003

(54) Method and system for the management of structured commodity transactions and trading of related financial products

(76) Inventor: Anil Suri, Tarrytown, NY (US)

Correspondence Address: GOODWIN PROCTER & HOAR LLP, 7 BECKER FARM RD, ROSELAND, NJ, 07068, US

(21) Appl. No.: 10/077,611

(22) Filed: Feb. 15, 2002

Related U.S. Application Data
(60) Provisional application No. 60/281,448, filed on Apr. 4, 2001.

(51) Int. Cl. G06F 17/60

(52) U.S. Cl. 705/1; 705/412

(57) ABSTRACT

A utility resource transaction and management method accessible by a plurality of users over a computer network comprising, defining a database in a host computer having a processor and an interface device, storing in said database information pertaining to a plurality of utility resources, providing at least one customer with access to said database information pertaining to a plurality of utility resources; receiving into said host computer information pertaining to an exchange of said utility resources from at least one consumer, calculating a plurality of exchange constraints based upon said information pertaining to an exchange of said utility resources, establishing an exchange correspondence between said at least one consumer and said utility resource based upon at least one exchange constraint and providing an computer accessible exchange report.

### BACKGROUND OF THE INVENTION

The present invention generally relates to computer systems for buyers and sellers of commodity and commodity-like assets to manage their portfolios according, to predetermined preferences or criteria, to their volumetric and price expectations for the purchase and sale of the assets, respectively, and, more particularly, to a computer implemented process, which when given a set of parameters will return transaction sets that match objectives relating to volume, price, risk and other target criteria specified in advance by the user (i.e. seller or buyer, in their respective transactional roles), each such transaction set being capable of being evaluated against, and negotiated to meet, the foregoing objectives. The parameters provided as input to the computer process with which to evaluate a transaction include:

(1) a set of time-based volumetric and price expectation data for one or more buyers of the assets,

(2) a set of time-based volumetric and price expectation data for one or more sellers of the assets,

(3) data to compute various financial risk indices corresponding to historical and/or expected transactions between buyer and sellers of the assets,

(4) non-price and non-volumetric parameters for transactions that are relevant in the evaluation calculations, and

(5) data on counterparty risk characteristics,

While the present invention is designed to operate in any industry with any commodity or commodity-like asset, it is well suited for application in industries where deregulation or other market forces have created the need for, or made possible, optimization of transactions involving the sale and purchase of assets through disaggregated risk analysis of the transaction using specific transaction criteria. Therefore, in order to more specifically describe the features of the present invention, it will be described with respect to the purchase and sale of energy commodities. More specifically, information is provided for transactions involving the purchase and sale of electricity.

In the environment that existed prior to Federal Energy Regulatory Commission (FERC) 888 (which opened the transmission and distribution lines for electrical power), a reasonably straightforward relationship existed between the physical flow of electricity and the financial flow of payments for that electricity. The electricity market was vertically integrated, with most public utilities owning the electric generation assets and being responsible for supplying electricity to commercial and retail customers in particular geographic regions. (FERC) 888 was passed to encourage greater competition and more efficient resource allocation in the wholesale electricity market. By opening the wires to all, it allowed for the break up of vertically integrated companies so that, in any given region, generation, transmission and distribution assets and load service obligations could belong to different companies. The effect of this “deregulation” of the electricity market has varied on a state-by-state basis and region-by-region basis across the country. In most markets, however, the physical flow of electricity remains substantially the same (i.e. regional generation generally serves the local area load), but the financial payment flow and hence financial exposure can be markedly different from the underlying electron flow. This fragmentation of the financial marketplace has created enormous exposure to price fluctuations that did not exist in the old, vertically integrated framework. As a result, electricity companies have been required to develop complex risk and portfolio management strategies to hedge exposure and to maximize value for their businesses.

There are several unique attributes to electricity. One, it is a manufactured commodity derived from other natural resources. This means that a generator or a manufacturer of electricity has, at any given time, an option to generate electricity whose value depends upon the relative worth of output electrons and input commodities such as gas, oil or coal. In financial terms, a generator is a manager of a long position in options whose value can vary greatly as is evident from the volatility of price of electricity in the US. The second unique attribute of electricity is that it is not storable in any meaningful quantity. Therefore, the supply and demand of electricity must be in balance continuously, thus creating the need for a centralized pool operator to continually balance supply and demand. Because electricity must always be in balance, variations in supply or demand caused by unforeseen events (unexpected generation outages or unforecast weather, for example) create extreme price volatility. The third unique attribute of electricity is that the end users of electricity have an option to turn power on or off at will, essentially exercising an option to purchase available power in the system. Thus, a seller of electricity to end-use customers is a manager of a short position in options whose value can vary greatly. The fourth unique attribute of electricity is that overall electricity usage varies greatly and in a predictable macro pattern over the course of a day, over a week, over a month and over the year. Essentially the usage pattern reflects the fact that when the general populace is awake and working a greater amount of electricity is needed than when it is asleep or not working. The seasonal usage pattern reflects the overall weather pattern and the subsequent heating or cooling needs of the particular region. Thus, electricity usage has a predictable overall volume versus time shape of usage while exhibiting unpredictable usage pattern due to the weather and other unforeseen circumstances. Because the interaction between all of the above listed factors is highly complex, many market participants are unable to manage and optimize their long and short positions as needed to efficiently manage and control risk in this business. As a result they underutilize their assets and expose themselves to severe risks.

From a resource allocation and procurement point of view, both the generators and end-user suppliers of electricity need to forecast their output and demand as accurately as possible and then manage their portfolios according to their volumetric and price expectations. Currently there are several marketplaces they can utilize as tools for portfolio management:

a) the spot market (does not allow any price exposure management but generally allows volumes to be managed);

b) standard block products sold by voice or electronic brokers and market makers (standard block products allow for limited price and volume exposure management);

c) over the counter shaping of power by a few sophisticated power structuring desks of investment banks and energy companies and;

d) a Request For Proposal process involving issuing written documents to potential counterparties and negotiating with each one separately to try to come to terms. (this process can be inefficient and expensive, requires portfolio disclosure to counterparties and can lead to significant market exposure, should prices move during the negotiation process).

The sole use of standard block products to manage volumetric and price exposure is akin to trying to fit a square block in a round hole. The residual exposure from the remaining unsold generation or unmet demand can often lead to even bigger financial exposure than the originally desired transaction. Over the counter transactions for structured transactions are often expensive, inefficient and non-transparent. Thus, while the ability to buy and sell “structured” electricity products that reflect variable demand/supply curves is critical for efficient portfolio management, a generator or a load supplier currently has very limited tools to evaluate and marketplaces to execute these types of transactions.

The reason such products are expensive is that it takes specialized knowledge of advanced risk management techniques, information systems, financial modeling, and time to disaggregate a given transaction into its hour-by-hour components and then syndicate the sourcing of the need. In addition, measuring financial risk of these transactions requires sophisticated multi-variable modeling.

It is therefore an object of the present invention to provide buyers and sellers of commodity and commodity-like assets with a computer system to assist them in their portfolio management decisions related to:

A) the volumetric and price expectations of the buyers or sellers for the purchase and sale of the assets, respectively;

B) the counter-party risk and delivery expectations for the purchase and sale of the assets, respectively;

C) the evaluation of volumetric, price, counter-party and delivery risk characteristics of asset sale/purchase transactions, including, among other ways, anonymously or with full transparency;

D) disaggregating asset sale/purchase transactions into volumetric pieces (which can be in any time/unit groupings) and syndicating the procurement or sourcing for these transactions within the specific disaggregation constraints or criteria specified by the users and optimized for parameters chosen by the users from volume, value or risk based measures, one-to-multiple and multiple-to-one counterparty online negotiations, on-demand risk measurement of any transaction in the system, on demand what-if portfolio analysis for risk and value impact of any transaction in the system and ongoing management of residuals (in time scales ranging from the next hour to at least the next five years); and

E) negotiating and executing the sale/purchase of assets electronically using specific volumetric, price, counter-party and delivery risk criteria.

### SUMMARY

The present invention provides a transaction platform for designing, structuring, evaluating and executing transactions in a highly volatile and complex marketplace, while taking into account a plurality of user defined parameters based upon that users individual risk factors.

According to the present invention there is provided a utility resource transaction and management method accessible by a plurality of users over a computer network comprising, defining a database in a host computer having a processor and an interface device, storing in said database information pertaining to a plurality of utility resources, providing at least one customer with access to said database information pertaining to a plurality of utility resources; receiving into said host computer information pertaining to an exchange of said utility resources from at least one consumer, calculating a plurality of exchange constraints based upon said information pertaining to an exchange of said utility resources, establishing an exchange correspondence between said at least one consumer and said utility resource based upon at least one exchange constraint and providing an computer accessible exchange report.

### BRIEF DESCRIPTION OF THE DRAWINGS

These and other objects and advantages of the invention will become more apparent from the following detailed description of a preferred embodiment of the invention when taken into conjunction with the drawings wherein:

FIG. 1 is an exemplary computer system for implementing the present invention.

FIG. 2 is schematic of the various subcomponents and identification of devices used within the present invention.

FIG. 3 depicts an interactive computer screen implemented in connection an embodiment of the present invention.

FIG. 4 depicts an interactive computer screen implemented in connection an embodiment of the present invention.

FIG. 5 depicts an interactive computer screen implemented in connection an embodiment of the present invention.

FIG. 6 depicts an interactive computer screen implemented in connection an embodiment of the present invention.

FIG. 7 depicts an interactive computer screen implemented in connection an embodiment of the present invention.

FIG. 8 depicts an interactive computer screen implemented in connection an embodiment of the present invention.

FIG. 9 depicts an interactive computer screen implemented in connection an embodiment of the present invention.

FIG. 10 depicts an interactive computer screen implemented in connection an embodiment of the present invention.

FIG. 11 depicts an interactive computer screen implemented in connection an embodiment of the present invention.

FIG. 12 depicts an interactive computer screen implemented in connection with an embodiment of the present invention.

### DETAILED DESCRIPTION OF THE INVENTION

Definitions

While formal definitions may also be implied by the usage of certain terms herein, within the context of this application, the following definitions are provided for the following words and terms.

Standard Energy Transactions or Standard Transaction.

Standard energy transactions are for buying and selling standard energy including peak (5×16 or 6×16), around the clock (7×24), and various off-peak and weekend products. The product term can range from the next day through the current year, out to a five-year period. It should be noted that while the structure of the product is standard, i.e. (5×16 or 6×16), there is no standard MW size. Settlement can be physical or financial; pricing can be fixed or indexed.

Transmission Transactions

A transaction involving the buying or selling of standard blocks of transmission. The structure of the Transmission market is very similar to that of the standard energy market. Users have the flexibility to post bids/offers for both point to point and network transmission markets . The product term can range from the next day through the current year and out to five years. It should be noted that while the structure of the product is standard, i.e. (5×16 or 6×16), there is no standard MW size. Settlement can be physical or financial. Pricing can be fixed or indexed.

Real-Time Transactions

A user can buy and sell hourly energy blocks for the next 48 hours using the current invention. The structure of the real-time market is similar to the standard and transmission markets.

Ancillary Services Transactions

Users can buy and sell standard blocks of ancillary services. These standard products include peak, around the clock and various off-peak products. The product term can range from the next day through the current year and out to five years. It should be noted that while the structure of the product is standard, i.e. (5×16 or 6×16), there is not standard MW size. Settlement can be physical or financial.

Structured Energy Transactions

Structured energy products are custom designed to suit the individual user needs. The user can structure energy products to the hourly level detail by submitting hourly load and price shapes. Settlement can be physical or financial. Pricing can be fixed or indexed. Volumes can be indexed to actual pool settlement volumes.

Options on Energy and Transmission

Options on underlying energy and transmission products are designed to provide users with additional flexibility to manage their portfolios. These options may be simple calls or puts on the underlying energy/transmission products. Options on energy can also be swing options, providing the buyer the option to take definitive percentages less or more than the underlying energy product. Additionally, options on energy can be lookback options, providing the buyer with the ability to financially settle prices against actual hourly clearing prices after the fact.

Generator Tolling

For the purposes of the description of the present invention, a tolling transaction represents an exchange of gas at a particular location for electricity at a particular location. The volume of gas inputs and the volume and timing of electricity outputs are predetermined by a negotiated conversion rate and specific dispatch parameters for the electricity. The predetermined volumes may have some flexibility. There can be additional fixed and variable fees for the tolling service. Settlement can be physical or financial. Non-performance penalties are explicitly defined. However, it will be apparent to one skilled in the art that the exemplary tolling transaction could be modified for use in trading a variety of commodities and products.

The present invention will now be described in detail with reference to the accompanying drawings. While the present invention is described in the context of an Internet based communications network, which includes a specific number and type of components, the system of the present invention may be incorporated into data and voice communications networks of many structures and sizes. The drawings are intended to provide one example of a communication network configuration in which a system of the present invention may be implemented and are not intended to limit the applicability of the present invention to other network configurations.

With reference to the various systems and methodologies of the present invention, as described below, aspects of the present invention are described in terms of steps, some of which being executed or executable on a computer system. Various implementations of the inventive systems and methodologies provide a comprehensive, multi-faceted; multi-user based transaction system and method. In accordance with these implementations, there is provided a system and method for implementing a transaction platform for designing, structuring, evaluating and executing transactions in a highly volatile and complex marketplace, while taking into account a plurality of user defined parameters based upon that users individual risk factors.

Although a variety of different computer systems can be used to implement the features of the present invention, an exemplary computer system is described as follows.

Computer system includes a host computer having a processor, main memory, a secondary memory comprising a hard disk drive and a removable storage drive. The exemplary components of host computer are operably connected via an address/data bus, which is not specifically designated. Memory can, and preferably does include a volatile memory (e.g. random access memory), which is coupled with the data bus for storing information and instructions for processor, and a non-volatile memory (e.g. read only memory) coupled with the data bus for storing static information and instructions for processor. Data storage device can comprise a mass storage device. Host computer constitutes a hardware platform, which executes instructions to implement the application program(s) described below. Accordingly, the system as described above can be implemented as an integral stand alone system, or can include separate component parts which are interconnected and operable for implementing the invention described below.

Interface device preferably comprises a multi-user network interface (e.g. an Internet interface), which couples computer system to a multi-user system (e.g. a Wide Area Network (WAN) such as the Internet in one embodiment of the present invention). Interface is coupled to permit communication with various application programs contained on the hardware platform defined by computer system. The Interface can typically be implemented using a graphical user interface (GUI) incorporating pull down menus and data entry fields.

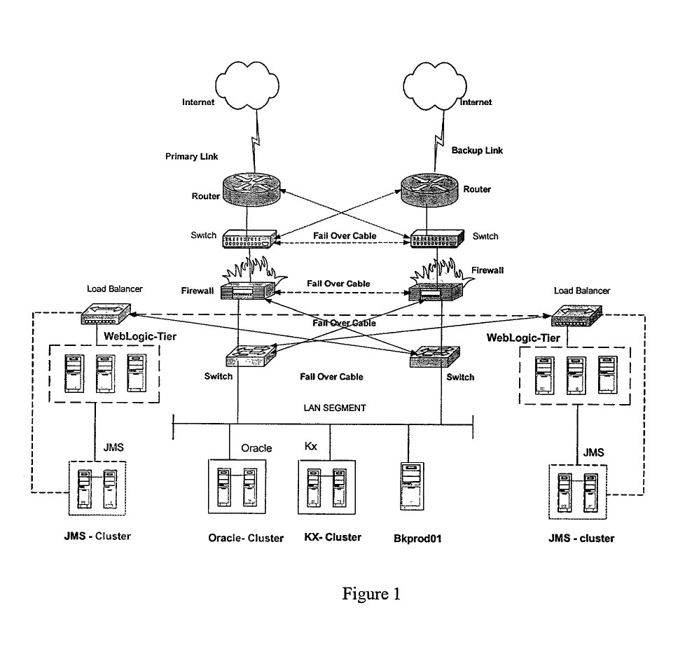

As mentioned above, and in one implementation of the present invention, the interface device comprises an Internet interface. The Internet is a well-known connection of worldwide computer systems that operate using a well-known Internet protocol. The Internet is one type of multi-user computer system. Other Internet applications (e.g. using specific protocols) operate on top of the Internet protocol. One such application is the well-known World Wide Web or “www” Internet application that operates using the bypertext transfer protocol or http. The “www” Internet application is a “demand system” in which user requests information from a site and the site transfers the information back to the user on-line. Also well known is the email Internet application which operates using the simple mail transport protocol or SMTP. The email Internet application is a “present system” in that an information transfer command originates from a sender site and information pursuant to that command is presented to the target email address. Another Internet application is the file transfer Internet application that operates using the file transfer protocol ftp. In one embodiment, the present invention utilizes the www, email, and file transfer Internet applications as well as the http and https protocol. Other embodiments of the present invention can be implemented in other multi-user computer environments. For example, the present invention could be implemented with a dedicated multi-user system. In view of the foregoing computer system description and in accordance with one aspect of the invention, the reader is referred to FIG. 1. There, an exemplary computer system or host system can be seen to comprise part of a network, which includes a database, a server and a user or users. In the context of this document, the server will be understood to include computer hosting the program that embodies the current invention, the server controlled by the server logic (software) and a database for storing site content and input data. Similarly, the term “user” as used in this document will be understood to include a buyer or seller of commodity goods or services.

The computer system described hereinbefore supports a software configuration, which operates under control of a conventional operating system. The operating system permits various application processes to be executed. These include, for example, a communications application that permits data transfer with various remote terminals as will become apparent below. The software environment further includes a data management, storage, and retrieval application that is utilized in connection with data storage device. The data management, storage, and retrieval application organizes and stores information, which will be described in greater detail below. This information is organized and stored within the environment of the operating system on one or more mass storage devices such as data storage device. Other applications conventionally known may be included in the software environment comprising computer system.

The present invention can be implemented with a software program executable on computer system. Such program would typically be stored in a non-volatile memory of a network computer system.

The interface of the present invention is described as being presented to the user through the graphical user interface of an Internet browser program. The browser's graphical user interface (e.g., Microsoft Internet Explorer or Netscape™ Navigator™) presents content provided by a resource (e.g., a file) at a URL (Universal Resource Locator). The content can include graphics, text, animation, sound, instructions, etc. A URL can refer to a location on a remote computer that stores the content as data and presentation instruction. The presentation instructions and data can be in a variety of formats such as HTML (Hypertext Markup Language), XML (Extensible Markup Language), PDF (Portable Document Format), JPEG (Joint Photographic Experts Group), Java ‘.jar’ (Java Archive) files and MPEG (Moving Picture Experts Group). When browser requests content from a URL resource, a remote computer providing the resource can transmit the content to a browser for presentation. As shown, the browser is an independent application, however, other applications (e.g., an e-mail program, a word processor, or a spread-sheet) can incorporate functions traditionally performed by the browser.

The Graphical User Interface guides the user through the application through a standardized flow. In the present invention, the user interface is designed so that once the user inputs required information, successive steps are presented automatically.

The data is permanently stored using a database server. The database server is an application program that interacts with a database. Generally, the functions of the database server are to receive requests for information directed to the database, format the requests into queries that are understood by the database, submit the requests to the database, receive one or more results from the database, format the results, and deliver the formatted results to one or more other application programs. For example, the database server may receive a request for information in the database in the form of a Structured Query Language (SQL) statement that identifies one or more tables in the database. The database server verifies that the SQL statement has correct syntax and identifies information that is actually in the database. The database server submits the SQL statement to the database and receives a result set of records from one or more database tables.

The browsing engine is an application program that interacts with the other application programs to carry out a method of browsing a hypertext system in the manner described further herein. Generally, the browsing engine establishes one or more connections with one or more servers, presents a view of hypertext documents and other data in the database to the users, receives information that identifies which documents and data in the database are relevant to the users, creates a ranked list of the documents based upon the relevance information, and provides the ranked list to the users. Other functions of the browsing engine are apparent from the description herein.

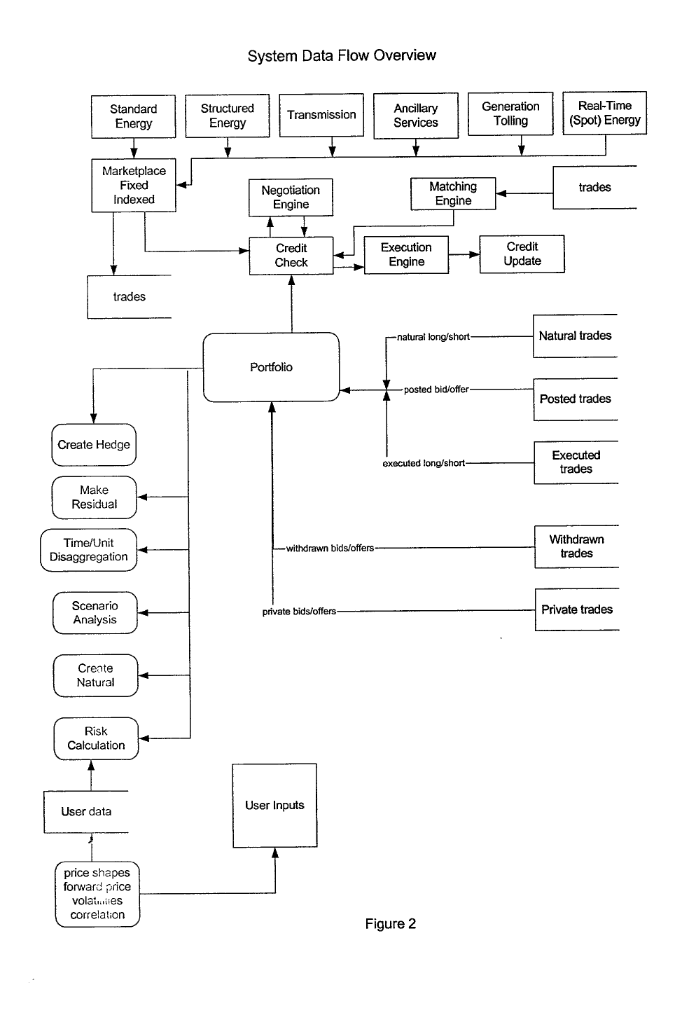

The operating software configuration described above supports the computer software application, which embodies the present invention. The computer application software is comprised of various modules for performing each functional requirement of the present invention. The various modules and their interaction are depicted in a System Data Flow Diagram referred to as FIG. 2. Turning now to FIG. 2 the exemplary data flow diagram representing the logic modules and input/output devices of the present invention is shown. Depicted are the Client/User Interface as well as logical devises representing functional modules of the present invention. The logical devises include a; Display Device, Negotiation Device, Credit Device, Execution Device, Trade Disaggregating Device, Residual Management Device, Hedge Device, Time/Unit Disaggregation Device, Scenario Analysis and Device, Transaction Linking Device, Transaction Matching/Syndication Device, MTM/VaR Data Device, Positions Device and Risk Calculation Device. The operation and function of each of these logical and input/output devices is described below.

The browsing engine is an application program that interacts with the other application programs to carry out a method of browsing a hypertext system in the manner described further herein. Generally, the browsing engine establishes one or more connections with one or more users, presents a view of hypertext documents in the database to the users, receives information that identifies which documents in the database are relevant to the users, creates a ranked list of the documents based upon the relevance information, and provides the ranked list to the users. Other functions of the browsing engine are apparent from the description herein.

The operating software configuration described above supports the computer software application, which embodies the present invention. The computer application software is comprised of various modules for performing each functional requirement of the present invention.

Client/User Interface:

Client/User Interfaces provide the capability for all online users to see and interact with others in a real time environment. Users see changes to the marketplace as they and other users add/delete/modify transactions. The details of each transaction can be viewed as discussed above for each transaction type in the marketplace. Users also interact with each other using the Negotiation Device (discussed below) and ultimately the Execution Device (also discussed below) as transactions get executed.

Display Device:

The viewable marketplace is the device for displaying transactions. The system contains a general marketplace component, and within the marketplace are distinct transaction types that are displayed in separate tabs/screens. Sumrnary level descriptions of each transaction are contained within a single row in each marketplace, as simple transaction parameters or statistics. Highlighting a row and right clicking to view details allows users to see all of the major transaction parameters. For structured transactions where the combinations are infinite, the user can view charts, tables or even download all of the hourly price and volume information.

A second approach for viewing transactions is through the “View My” option. This is a button in each of the marketplaces. Hitting it allows users to view that status of all of their transactions, whether they are posted (open, future or executed), withdrawn, expired, on hold or private.

Display Device Algorithms

The Display Device consists of two components. First is the transaction template, where the user provides all the details of a transaction, such as location, price type, date range, price, size, etc. There are no calculations performed in any of these transaction templates, except for Generator Tolling. Within the Generator Tolling transaction, the following calculation is performed as the transaction is being created:

monthly size≦plant output

minimum volume,MWh≧(minimum size, MW)×(minimum # of scheduling days)×minimum number of scheduling hours/day)

(maximum volume, MWh)≦(maximum size, MW)×(maximum # of scheduling days)×(24)

These calculations are performed for each month of the transaction term. They represent feasibility tests for the transactions.

The second component of the Display Device is the main marketplace template for each transaction type. Each row displays some basic details of a transaction. There are no calculations performed in these marketplace templates with the exception of Structured Energy/Options. In these cases, the calculation is the displayed value for load factor (%) and price factor (%). These calculations are defined in the Risk Calculation Device section (within Definitions).

Within the Display Device, users can quickly download and upload transaction data by copying information into a system-contained clipboard, and directly pasting that information into spreadsheets, such as Excel. This same information can be copied and pasted back into the system.

Negotiation Device:

Negotiations can be launched for transactions once both users have the ability to execute a deal with another user (because the combined criteria of sufficient credit and ability to conduct certain transaction types are met). The negotiation session is one-on-one and anonymous until a transaction is executed. The initial submitted negotiation comes from one user to the originator or the transaction. The same transaction may undergo simultaneous negotiation sessions.

For standard energy, real time energy, transmission and ancillary services, the negotiable parameters are price and size. A basic negotiation session for structured energy is similar in that weighted average price and total volume are negotiable. These parameters are similar because the effective price and volume shape of the structured transaction remain intact when only these parameters are negotiable. Structured transactions may also undergo a flexible negotiation session, where the start/end dates and the detailed price shapes and volume shapes can be modified at the hourly level. When such negotiations take place, users are given the ability to hit a recalculation button, a feature that provides them with updated calculations regarding several of the basic deal statistics they have changed, such as min/max prices and volumes, and weighted average price.

The negotiations for generator tolling are different in that the parameters are fixed and variable fee and conversion rate. In this transaction type, the details of the effective exchange of gas for electricity have been defined. The conversion rate dictates that exchange rate. And the fixed and variable fees specify the details for the basic cost to provide that tolling service.

Negotiations are also available for option transactions (options on standard energy, structured energy and transmission). The negotiable parameters are identical to those for the underlying product, plus the option premium.

The negotiation process behaves as follows: The first set of values is submitted to the originator by a qualified counterparty. When a user submits values, they are not binding, but represent indicative values. Values become binding when the user makes the request that its bid/offer status be “Accept”. Only when both parties are in the accept status is a negotiated transaction executed. Once the first submittal is made, either party can make the next submittal (so it does not have to be in back and forth sequence). When accepting values, the user can also specify time limits in hours for which those accepted values are valid. If the other party does not accept those values in that time period, then the negotiation status reverts to “open.” Negotiation time limits do not have to be specified. If unspecified, the acceptance period is until the transaction itself expires. Note, however, that the party first accepting values can at anytime change that status. When a negotiation session is active, both participants to the negotiation will see a negotiation icon in the marketplace, associated with the particular transaction.

To change values in a negotiation, a user places values into the “Enter” field in its negotiation template. When those values are submitted or accepted, those values shift to the Current value field. These are the values both parties see, and are the values that can be accepted.

If one party wishes to reject a negotiation session, it hits the reject button within the negotiations template and that session is gone. A new negotiation session can be launched so long as the transaction is still in the marketplace.

The status of a negotiation session changes to No Longer Negotiable if a transaction is no longer in the marketplace. This can occur when the transaction is deleted, withdrawn, expires, is executed or is moved to private. If that same transaction is later placed back into the market, a new negotiation session must be launched.

Once a transaction is accepted by both parties, it is considered executed and the transaction is removed from the marketplace. At that point both parties receive notification of the transaction (with transaction details) and the party names are revealed.

Negotiation Device Algorithms

In general, calculations are not performed within the transaction negotiation templates. The exception to this is for Structured Energy/Options. If a user makes direct changes to total volume or weighted average price, then the system will linearly scale (up or down) the hourly volumes or prices such that the current shape of volumes or prices remain intact. Here, no other calculations need to be performed.

If, however, the user elects to change load factor (%) or price factor (%), or the date range, then this is accomplished by modifying volumes or prices at the hourly level. The resulting price factor (%) and load factor (%) are automatically recalculated according to the methodology described in the Risk Calculation Device section (within Definitions).

Finally, within the negotiations template for Structured, the user can hit the recalculate button, which will also calculate an updated transaction VaR. This VaR calculation is explained in the MTM/VaR Data Device section.

Credit Device:

Within the marketplace tab is a credit device for companies to specify credit limits with all other companies possibly utilizing the system. An administrator sets up at least one account that has the ability to input and modify credit limits for each company user. The credit limits are specified as maximum buy or sell limits in dollars. With the exception of generator tolling, the dollar impact of all transaction types is the contract value. Each time a transaction is executed, the buy/sell limit is compared to the current buy/sell dollar value. If an incremental transaction (when added to the current credit exposure) hits the credit limit, then there is no credit available and incremental transactions cannot be negotiated and executed until the credit limits are updated. Users will receive messages that credit limits have been exceeded when attempting to negotiate.

Credit Device Algorithm:

Is (buy/sell $ limit)>=(Current buy/sell position)+(Proposed buy/sell position)?

If yes, transaction can proceed (simple buy/sell or negotiation). If not, message is generating stating that credit limit has been exceeded.

The proposed buy/sell position =(Mwh volume)×(contract price) for all transaction types except Generator Tolling. For options, contract value is the option premium multiplied by the volume of the underlying product. For tolling, the proposed buy/sell position is the market value of the transaction because there is no contract price for tolling other than fees. The proposed sell position of a Generator tolling deal is:

(Gas volume, MMbtu)×(Gas price, $/MMBtu)−(Electricity volume, Mwh)×(electric market price, $/Mwh)+fixed fees+variable fees.

From the perspective of a buyer of a Generator Tolling example, the $ credit impact is the same with the signs reversed.

If the value is less than zero (based on market data assumptions), the $ credit is the greater of the calculated value and zero. The $ credit impact cannot be negative.

The person assigned to update credit limits can do so at any time, and is expected to make periodic updates from information in their own credit systems. The system only keeps track of the credit impact associated with incremental transactions from the time the person has updated credit information for the user. These credit impacts are at the user level, not the company level.

The ability to negotiate and execute is also tied to permissible transaction types, not just credit exposure. In the same manner as credit is handled, a user can specify all of the transaction types that are permissible between a counterparty and the user.

Credit exposure can also be controlled by users by contract term, contract end date, and total $ credit exposure by calendar month.

Execution Device:

Execution of requests on the system is done through selecting tabs/buttons in the application, all of which are fairly self-explanatory. As necessary, all other users see the results of any executed request online, where that information is relevant. The changes occur online, with these updates not requiring any user “refreshing” of screens unless specifically noted.

Execution of transactions occurs when a user requests a buy/sell (where permissible in the system) or when both parties (or users) to a transaction accept the same terms of a negotiation process. When this occurs the system automatically removes the transaction from the marketplace, and both users receive notification with the details of the relevant transaction. The result of the execution is also noted in the Positions Device (discussed below) and can be further evaluated on an ongoing basis using the Risk Calculation Device (which computes MTM/VaR on an ongoing basis).

Execution Device Algorithms

There is only one calculation performed within this device. Transaction details are published in an e-mail sent to designated users. The details include total transaction volume in MWh, and simply represent the summation of hourly volumes for the entire transaction.

Trade Disaggregating Device and Algorithm:

When transactions are evaluated from a market risk perspective (market position and MTM/VaR), they are disaggregated into monthly peak and off-peak equivalents for market valuation. The technique used is to take each hour's volume and each hour's price in each monthly subperiod to derive a market value and a contract value. The volume shapes are based on the specified transaction. The price shapes are based on the pricing terms (in the transaction) and the market prices (monthly forwards). There are user inputs for price shapes at the hourly level which are used to derive hourly market prices from monthly forwards.

Specifically, for each calendar month-end subperiod (peak and off-peak), each hour's volume is multiplied by each hour's market price. The hourly market price is derived from a monthly forward price multiplied by an hourly price shape factor.

The hourly price shape factors are such that the maximum value in any hour is 1.0 (for a monthly subperiod) and all other factors are <1.0. The sum of all of the hourly shape factors is the subperiod divided by the total number of hours in the average price shape factor. The ratio of hourly shape factor/average shape factor x subperiod forward price market price (for that hour).

The summation of the hourly (prices)×(volumes)=total market value.

Total market value/subperiod forward price=(disaggregated monthly market position, MW).

Disaggregated market positions are used in the MTM and VaR calculations discussed in that section.

These monthly subperiod components represented the disaggregated position of each transaction. The consistency of this approach is important as it allows for simple combining of transactions for MTM and VaR calculations (discussed below).

This disaggregation occurs for the following transaction types: Standard energy, structured energy, transmission and generator tolling. For standard and structured energy, the monthly subperiod (peak and off-peak) equivalent products are created directly from these energy products, using the technique described above. For energy transactions that are index priced, the disaggregation is into two market positions. The first is either the location (if physical) or the settlement index (if financially settled) and the market associated with the price index.

For transmission, the disaggregation is the combined effect of long one location and short the other location. For a buyer of transmission, the “to” location represents the long market position and the “from” location represents the short market position. If the transaction is physical, then transmission losses are taken into account. For example a 100 MW transmission purchase from location A to location B would result in a 100 MW short position at A and a 95 MW long position at B, if defined losses from location A to location B is 5%.

For generator tolling transactions, the disaggregation is a position in gas and a position in electricity. The buyer of a tolling transaction is long electricity and short gas, where the amount of each is driven by the conversion rate (gas to electricity (Btu/KWh)) and the parameters defining the electric tolling volumes in the transaction details. These monthly volumes are specified per month. These volumes may be fixed or they may be flexible (flexible means a minimum and maximum volume range is specified each month). From a market evaluation perspective (and disaggregation measurement), the volumes are assumed to uniformly fill the monthly peak subperiod first, with any remaining volumes uniformly filling the off-peak subperiod. Specified scheduling constraints are taken into account when determining peak vs. off-peak volumes in each month. When the volumes are flexible, the volume assumed utilized is whatever is either the minimum or the maximum, whichever option is most economic from an MTM perspective. That MTM is from each user's perspective. The difference in volume between monthly minimums and maximums is an option on that volume difference. The system captures the in-the-money value or intrinsic value of that volume.

The allocation calculation of electricity volumes for each monthly subperiod is as follows:

1. Calculate total possible MWh in monthly subperiods

Maximum peak MWh=(MW size for month)×(peak hours/month).

2. Examine minimum number of scheduling hours/day. If>16 hours, then (minimum number of scheduling hours/day -16)/16×100=% minimum allocation to the off-peak subperiod.

3. Compare (specified monthly volume)−(maximum peak MWh volume) with (specified monthly volume)×(% minimum allocation to off-peak subperiod). The greater of the two volumes is the off-peak volume used in the allocation of volume to the off-peak subperiod.

Residual Management Device:

The system contains the ability for users to compute and manage residual positions within the Structuring Tools tab. The Positions tab and features are contained within Structuring Tools. A residual represents the net position at a particular location from one or more selected transactions. A user first selects the option to go into residual management mode (from within Positions). At that time all posted/private bids and offers are listed in addition to a user's natural and executed positions. From here users can select subsets (or all) of these transactions to produce a set of residual market positions. Note that this can be a mixture of transaction types and price types and settlement types, as they have all get converted to hourly positions by location, which then get re-aggregated back to the monthly subperiod positions discussed above.

The design of the residual management feature is such that users are able to combine transactions in any way they choose. Some manage by location/region. Some manage by transaction type. Some manage by pricing type. The system design is flexible to accommodate any user philosophy in this light to compute their residual positions. A residual position is assessed based on what the position would be to a user if the selected transaction were to be executed.

Residual Position Algorithm:

Long positions represent positive positions and short positions represent negative positions.

If a party is long fixed price energy, the party has a positive position at that location or settlement index (if financial).

If a party is long index priced energy, the party has a positive position at that location or settlement index (if financial) and an equivalent negative position at the location corresponding to the price index.

If a party is long transmission (location A to location B), the party has a negative position at location A and an equivalent positive position at location B net of losses (where losses are defined from A to B).

If a party is long generator tolling, the party has a positive position at the specified electricity location and a negative gas position dependent on the specified conversion rate. (Allocation discussed in previous section.)

The positions are all reversed if the party is short instead of long.

The residual position is represented by the cumulative volumes of all of the transactions or positions selected. The position is produced at the hourly level, and may contain a combination of positive and negative volumes in any given hour. If the sum of the total hourly volumes is positive, then the residual position is long, and vice versa.

Users can then view the details of their residual positions and further strategize how to incrementally manage their portfolio, through the Hedge Device (discussed below).

Hedge Device:

This device is used to create hedge transactions. Hedges can be created to offset a single transaction, or multiple transactions, whichever combinations are relevant to the user. In the Positions mode (within Structuring Tools), a hedge can be created to perfectly offset an existing executed or natural position. The hedge is the same transaction type, with all the same specific characteristics of the selected position, other than price which is purposely left blank for the user to specify based on market conditions. Hedges can be created only from standard energy, structured energy, transmission and generator tolling transactions. In the Residual Management mode, a hedge transaction may be created for any residual position that is created by highlighting one or more transactions and requesting the residuals (defined above). In this mode, the hedge transaction is always a structured energy transaction, because the residuals are represented by a net position in energy at a particular location (again at the hourly level). Prices are not pre-specified for hedges as they are determined by the user based on market conditions. Depending on the selection of transactions or positions in the residual management mode, the net positions or residuals may exist for more than one location.

Hedge Device Algorithms:

There is no distinct hedge device calculation, other than processing the residual volumes (per Residual Position algorithm described above). The residual position is then converted into a structured energy hedge transaction using those specific hourly residual volumes. The hedge is automatically created as a bid or offer based on whether the residual represents a net long position (offer hedge) or a net short position (bid hedge).

Time/Unit Disaggregation Device:

Once hedge transactions are created, they immediately go to a user's private portfolio. The exception is Generator Tolling, which goes directly to the posted marketplace because there is no private status for that transaction type. Transactions in the private mode can be viewed by going to the relevant marketplace, and then hitting the “View My” button. Within this area, the user clicks on the private tab to view these transactions. At that point, the user may elect to post the hedge as is, or modify it prior to posting it. One of the choices within private is to disaggregate the hedge into weekly, monthly or annual transactions prior to posting one or more of the components. The disaggregate button in the private tab automatically disaggregates the transaction by time unit that was already created, including the price. The user also specifies the date range for which it wishes the disaggregation process to occur. Disaggregation can be an effective strategy because posting products over particular time periods may be more common and therefore increases the chances for transactions to get executed in the marketplace. The disaggregated transactions remain in the private portfolio and can be posted as desired by the user. This function can be performed on standard energy, structured energy and transmission transactions. There are no specific algorithms contained within this device.

Scenario Analysis and Device:

The scenario feature resides within the Structuring Tools tab. It allows users to perform “what if” scenarios on MTM/VaR results for one or more positions that are contained within the specified scenario. Transactions are added to the scenario by simply highlighting the transaction and adding it to the scenario. Even transactions in the midst of negotiations can be added to a scenario. If done, the values that are computed are based on the Current values of a negotiation, as described in that section above.

The results from scenario analyses can be based on system assumptions and default data, or any combination of user/company defined data. That is one dimension to “what if” analysis. Another dimension to scenarios is as a screening tool, where groups of transactions can be quickly evaluated against MTM/VaR measure to select those transactions that appear most attractive from that perspective for future consideration. Another dimension to scenario analysis is the assessment of incremental transactions in the midst of negotiations. Users can use this structuring tool to evaluate the MTM/VaR benefits of a proposed transaction, and can include whatever other transactions it considers as relevant in this calculation. The results from this analysis are consistent with the calculations described in the trade disaggregation process.

Scenario Analysis Device Algorithm:

The MTM value of individual positions highlighted together within the scenario tab (could be in the market, private, natural, executed, or values in negotiation) are summed to produce the displayed MTM. The VaR is the total VaR of the highlighted positions, where the positions are first unbundled into their equivalent monthly peak and off-peak proxy positions added together. These cumulative proxy positions are then used to produce the correlated VaR. (See MTM/VaR Data Device section.) Residuals can also be requested from the Scenario template, and the calculation is identical to that described above in the Residual Management Device.

Transaction Linking Device:

A user's transactions can be linked to one another as part of a posting strategy. Because there are numerous ways in which structured needs can be displayed, users can show them in different ways in the marketplace and link them. When a transaction gets executed, any posted transactions in the marketplace linked to that particular transaction are immediately withdrawn by the system to prevent the chance that a need gets executed twice. Conversely, any linked transactions that are in the private status when the host transaction is executed is immediately posted to the marketplace. This permits users to incrementally post needs to the market where the next increment comes in after one segment is executed. There are no calculations involved in linking.

Transaction Matching/Syndication Device:

This feature produces results for the user for transactions, which are sets of transactions that are best suited to a user specified matching criteria. The results are optimized in the sense that the user is presented with up to the five best solution sets. Based on these results, the user then formulates a strategy for how to best proceed with negotiating and executing on the most attractive transactions).

When a transaction is created, the user is prompted specify a set of matching parameters. A basic matching criteria is selected, which is volume based, value based or VaR based. Volume based means to provide the best percentage match on a cumulative hourly basis over the transaction term. The percent match is determined by the sum of the absolute value of all of the hourly volumes, when comparing the matched transaction(s) to the original transaction. That is, if a user seeks to buy 100 MW in an hour a 90 MW supply has a deviation of 10 MW as does a 1110 MW supply product. In this case, both supply products provide a 90% volume match in that hour.

A value based match takes into consideration the price of the bid/offer. The matching volume and its price are used to produce a contract cost/value. Any volumes that are unmatched by the solution (residual volumes, by definition) are valued at the market (whatever assumptions dictated by the user—could be their own or the system's). The sum of the contract cost/value and the market cost/value of the residual determines the value/cost of this matching solution. If the user is seeking a match for a bid, then the best value solution is that yielding the lowest cost. If the user is seeking a match for an offer, then the best value solution is that yielding the greatest revenue.

A VaR based match is based on solutions that minimize the residual VaR to the user. This is not necessarily the same result as a solution that minimizes volume mismatches since there can be different volatilities associated with peak vs. off-peak volumes.

In addition to basic matching criteria, the user also specifies several other constraints for matching solutions, such as the minimum % volume match for any solution, the maximum number of transactions making up a solution, the minimum contribution (% volume match) of any single transaction, yes or no to financially settled transactions, and yes or no to transactions requiring transmission. With all of these constraints and basic criteria taken into consideration, the matching device goes through an optimization process to find the best solutions given all of the above mentioned criteria. The calculation approach involves a non-exhaustive process of testing combinations of transactions at different utilization rates, one at a time, adding each remaining transaction to the existing solution set to see if its contribution improves the overall solution set. Each transaction added is tested in 10% utilization and boundary increments, where the utilization range has been specified for the transaction at the time it is created. Finally, up to the five best overall solutions are displayed to the user.

Matching Device Algorithm:

Given the specified matching parameters, the matching engine performs the following calculations and optimizations:

1. Identify all transactions in the same location with the same pricing type.

2. Screen out those transactions that do not positively contribute to a volumetric match on a stand-alone basis, subject to the minimum percent contribution threshold.

3. Rank them from highest to lowest volumetric match (stand-alone).

4. Test highest ranked transaction with a utilization percent providing the best volumetric match.

5. With that transaction in the solution, test the next highest ranked transaction and test all utilization percents (highest and lowest), then in 10% increments in between to check if the matching solution improves. If this incremental transaction at its optimal utilization contributes to the matching solution and also contributes above the minimum % volume threshold, then add this transaction to the solution. Also check that the total number of transactions in a solution set is not exceeded.

6. Continue with all other potential matching transactions, following the same process in Step 5 until all eligible transactions are exhausted.

7. Retain this solution set. Go back to the very first (highest ranked) transaction and begin with its minimum utilization range. Repeat Steps 5 and 6.

8. Repeat Step 7 for the remaining utilization range (in 10% increments) for the very first transaction.

9. Now starting with the second highest ranked transaction, repeat Steps 4-8. In this calculation, ignore the highest ranked transaction.

10. Repeat Step 9 for all of the possible transactions, and in each calculation, ignore the previously highest ranked transaction. That is, if five rounds have already taken place, start with the sixth highest ranked transaction on a stand-alone basis. Only the seventh highest ranked and lower ranked transactions can be part of that solution set. At the end of this process only the lowest ranked transaction or a stand-alone basis remains, and it is the only transaction to optimize (by itself).

11. Report as the set of solutions the five highest ranking combination of transactions that make up a matching solution.

MTM/VaR Data Device:

The MTM/VaR calculation starts with each of the disaggregated transactions being converted into its proxy equivalent products as described in the section, Trade Disaggregation Device. The MTM calculation is simply the sum of the net volume position, where each location is broken up into two monthly subperiods (peak and off-peak). The MTM is the difference between the contract price and the market price for that volume, where the market price is equal to the designated forward price (system defined or user-defined). MTM's are additive, so the sum of the MTM's of any combination of transactions is simply the sum of the individual transaction MTM's. An individual transaction MTM may consist of the MTM's of its proxy product equivalent MTM's.

If the contract price is an index price, then the MTM calculation is slightly different. Each price index in the system is assigned to a particular locational market (or location with a designated forward price). For index priced transactions, the contract price side of the calculation is the forward price associated with that market index, adjusted only if the user has defined a specific “basis” or fixed price difference against that index.

Finally, if a transaction is financially settled (instead of physical), the settlement index is the market reference (not the physical location). Again, each settlement index is assigned to a particular market location or equivalent forward market.

The VaR is computed as a linear combination of proxy positions, utilizing a variance-covariance approach. The underlying products for which the VaR is determined are same proxy equivalent products used for the MTM calculations described above. These calculations take into consideration the current volatility of the underlying products, the forward price levels, the relationship or correlation of products with each other, the time period over which the VaR is measured (daily or weekly) and the confidence interval (95%, 99% ,etc.) The various market assumptions used for this computation will default to system assumptions (which can be viewed by the user) or can be based on user defined assumptions, or some combination of source of market assumptions.

### EXAMPLE

Suppose a client has proxy equivalent products A and B, and the current dollar positions using forward price levels at both these proxies are ωₐ and ω_{b}, respectively, σₐ and σ_{b} are the daily volatilities of A and B, respectively, and ρ_{ab} is the correlation between A and B. The daily VaR at 95% confidence interval, two tail, is computed as:

VaR=1.96×\sqrt{ωₐ²σₐ²+ω_{b}²σ_{b}²+2ωₐω_{b}ρ_{ab}}

The VaR of a portfolio with N proxy positions can be calculated as follows,

$$V a {R}_{P o r tfo l i o} = 1.96 \times \sqrt{{\sum }_{i = 1}^{N} {\sum }_{j = 1}^{N} {w}_{i} {w}_{j} {ρ}_{ij} {σ}_{i} {σ}_{j}}$$

The 1.96 factor becomes adjusted if either the confidence interval is different, or the VaR time horizon is different. The system inputs take annualized volatilities which are converted into daily volatilities for this calculation.

The system contains a MTM/VaR report which permits user to view these results according to various sorting and filtering criteria.

Position Device:

This device first allows users to create and display their existing portfolio, which consists of natural (previously existing) and executed transactions. It is from these positions plus transactions that are in the marketplace that are then used to create residual positions and hedge positions (discussed in Residual Management device). The same MTM/VaR capabilities are present here. Users can also request a positions report, which displays by month the market exposure or Mwh volume at each location, using the logic described in the trade disaggregation device. Users can also highlight any location for any month to view their exposure at the hourly resolution. There are no additional algorithms within this device as the displayed results are the same as residual positions.

Risk Calculation Device:

This device is the ability to produce MTM and/or VaR in various areas within the system. Transaction VaR can be viewed by transaction in the marketplace. MTM and VaR results are contained in detailed matching results. Within Structuring Tools, MTM and VaR are available in scenario analysis (see Scenario Device discussion) and also within the Positions Device.

A critical feature of the system is the ability to produce these results directly upon request by users. The system uses a queuing logic to produce results (transaction level first, groupings second and entire portfolios third).

The devices described above are utilized to implement the system of the present invention. They represent the integration of the marketplace for transactions plus the supporting tools and services necessary to make this marketplace function effectively. Separate from the system is the interaction of structuring agents, who work with users in conjunction with the system to execute the transaction types discussed previously.

The system is designed such that the various devices are fully integrated. That is, results generated from a particular device can serve as inputs or can be accessed from different devices or tabs within the system. This accessibility provides tremendous flexibility to users. For example, within the User Inputs tab, the user is can specify his interpretation of market information and enter it into the system. The Transaction Device contains transaction level details that can be aggregated into the Positions Device. Within the Positions Device the user can initiate the Hedge Device algorithms. Within the Hedge Device the user can request a risk calculation (MTM/VaR), which triggers a computation using the MTM/VaR Device. This is an illustration of how the system is designed to integrate the devices to the needs of users.

The following describes a typical user's basic interaction with the system, the system actions relating to the interaction, and results or output from the system actions.

The User begins by directing his browser to a web site embodying the present invention. Upon accessing the web site the User will be prompted for identity and registration information to establish and or confirm the Users identity using techniques well known in the art. After completing the log on procedure the User is directed to the system application's main page. On the main web page of the site the User will find tabs that represent links to the various sections of the system. Those sections include the various energy marketplaces as well as links to other supporting sections.

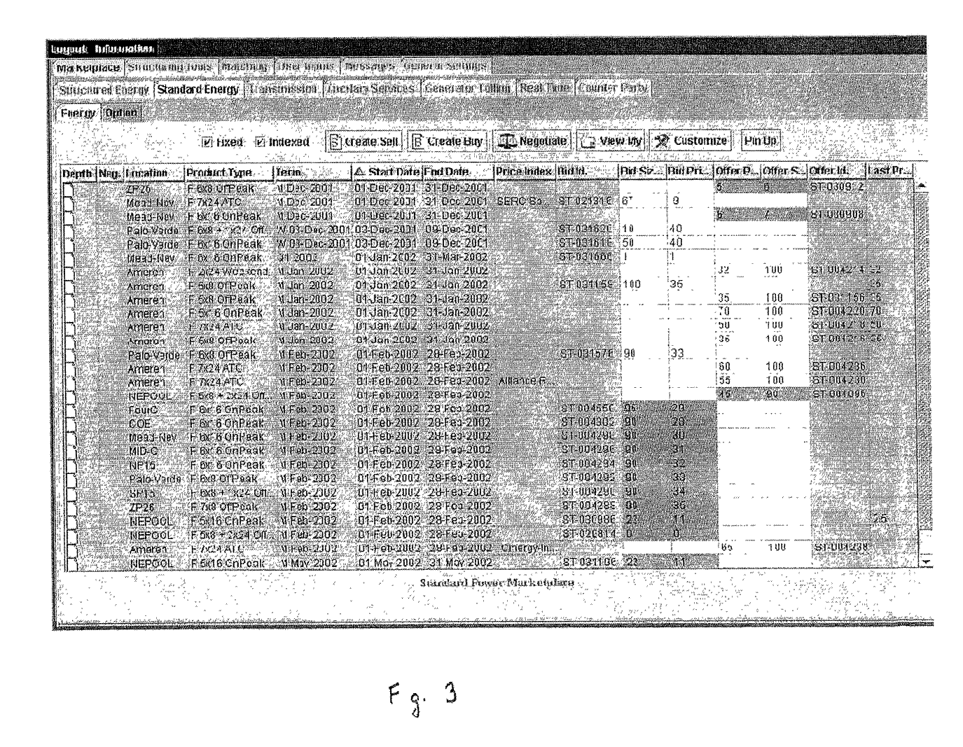

The energy marketplaces include; Standard Energy, Structured Energy, Transmission, Options, Ancillary Services, Generator Tolling, Real-Time Energy, and Counterparty. The supporting sections include Structuring Tools, Matching, General Settings, User Inputs and Messages. With respect to the energy marketplace screens, in general, the main screens for all markets have the same layout and format. The main screen for each transaction type presents the User with a spreadsheet type display, divided into rows and columns. Each row of the main screen represents a transaction, either a bid, an offer, or both, while the columns present specific information regarding each of the presented transactions. At a minimum, there is displayed the location of the deal, the transaction type, the tern, the date range, the bid/ask prices and volume. Users can sort the contents of the marketplace screens by clicking on the heading of most of the columns. Users can also rearrange the columns by dragging the columns with their mouse. In that way the User can view the presented information in a manner that is most conducive to the Users needs. Each column presents the User with a category of information regarding a plurality of transactions. The user can also customize its view by specifying only those transactions it wishes to view in the marketplace. FIG. 3 depicts a screen shot view of the Standard Energy Marketplace wherein there is displayed information regarding several transactions. The information is presented in accordance with the above description. The information presented in each column is as follows:

Depth—displays a predetermined icon, such as a folder if there are multiple bids and offers for the same product. This is only available for standard energy, ancillary services and real time energy. The product type, term and location must be identical for depth to exist. In addition, for an ancillary services product, the service type must also be identical. Clicking on that icon will display all bids for that particular transaction. The bids can be arranged in order of amount, time or other parameters chosen by the User. The highest price bid and the lowest priced offer will be displayed on the top row.

Neg.- , or Negotiation, displays a predetermined symbol if the user has any negotiations pending on either the bid or the offer listed on the row. In addition, a user will receive a notification message for negotiations initiated during the current login session.

Location—specific point within a geographic region for which energy is to be delivered. Each location is associated with a specific forward price.

Contract start and end dates—the starting and ending dates, respectively of the transaction.

Bid/Offer ID—a unique number identified for each transaction.

Bid/Offer size, or Plant o/p (for a tolling transaction)—the MW size associated with a transaction. For structured energy, the term bid/offer size represents a weighted average size, equal to the total Mwh for the transaction divided by the total hours associated with the specified date range of the transaction.

Bid/Offer price—the $/Mwh price associated with a transaction. It can be a fixed price or an index price, with or without a basis. A basis is a fixed $/Mwh difference from the index price. For structured energy, the term bid/offer price is a weighted average price, equal to the total contract value divided by the total hours associated with the specified date range of the transaction. If a structured transaction is index priced, the bid/offer price represents only the weighted average basis component.

Bid/Offer LF (or load factor)—pertains to a structured energy or structured energy option transaction, and is the weighted average size as described above divided by the maximum size for any hour of that transaction.

Bid/Offer PF (or price factor)—The information is this column pertains to a structured energy or structured energy option transaction, and is the weighted average price as described above divided by the maximum price for any hour of that transaction.

Product—For structured energy transactions, this is labeled as custom, but for transaction types where the hourly shape is defined, it represents the days in the week x hours in the day covered by the product, such as 5×16. The specific hour definitions are specified in the application.

Service type—The information in this column pertains to ancillary service transactions only and defines the specific ancillary service or services covered by the transaction, such as 10 minute spinning reserve. A more detailed definition and definition source are part of the application.

Last Price—Represents the executed price of the last transaction for the same product. Product type and/or service type, date range, price type and location all have to be identical for the product is considered the same.

Option type—The information in this column pertains to options only and defines the option as a put or call option, standard terminology for options.

Option product—This column list the type of option product, which can be either basic, swing or lookback. A basic option is an option on the defined underlying product, subject to other option parameters such as exercise frequency and option premium. The owner has the right, but not the obligation, to exercise the option on the underlying product, per the option parameters. A swing option is an option only on the portion defined by an option's flexibility up and flexibility down, both as relative percentages of the underlying product. The owner has the right, but not the obligation, to exercise the option on the difference between the flexibility up and flexibility down percentages defined in the underlying product, per the specified option parameters. A lookback option is a financially settled option which does not require an exercise decision. The settlement is simply to compare actual hourly clearing prices against the option strike price.

Exercise frequency—The information in this column pertains to options only and defines how often an option can be specified. It is either one time only, monthly or daily. The specific dates and times at which the option can be specified according to the specified frequency is contained in the application. This does not apply to lookback options.

Option premium—The information in this column pertains to options only and specified the $/Mwh charge to hold the option defined in the transaction. The energy or transmission product described within the option is also referred to as the underlying energy or transmission product.

By selecting a row, highlighting it and then right-clicking the mouse, users have a number of alternatives, depending on the transaction type, these choices include; view a transaction's details, view forward price histories and volatilities (where applicable), add transactions to the scenario, link transactions (if belonging to the user), modify matching parameters or view matching results (where applicable), show transaction VaR (where applicable), duplicate a transaction and edit, or withdraw your transaction. In the case of Standard Energy, Real Time Energy, Transmission and Ancillary Service bids and offers can be bought or sold by highlighting and right clicking. These transaction types may also be negotiated. All other transaction types must be negotiated for execution to occur.

The User can, through the interaction with the system of the present invention, carry out a plurality of tasks with respect to transactions relating to a particular commodity. While the present invention can be used for various types of commodity transactions, for the purposes of clearly describing the invention features, the users interactions will be described with respect to particular energy transactions below. However, it would be obvious to one of ordinary skill in the art that the steps and parameters described below may be interchangeable. Thus any particular transaction described is not meant to be limiting as to the particular elements and steps described but is only meant to be descriptive of various system features.

User Resources

In addition to the Marketplace of the present invention, there are provided a plurality of user resources for structuring and managing their transaction. User resources are made available to the user through the tabs on the main screen. By clicking on a tab, the User is able to access a variety of tools for managing transactions. Examples of this are given below in more detail.

Structuring Tools

In the present invention, a significant portion of the results from detailed calculations is contained within this tab. Users can represent portions or all of their portfolio within the Positions tab

Positions Tab

The positions tab enables users to view and create portfolio positions. The two main portfolio positions are natural and executed. Natural positions are user's long or short positions from their existing portfolio for all locations. The Positions tab is the only place where users can specify and view natural positions. Executed positions are those that result from completed trades within the Marketplace.

The Positions tab displays the following information in the columns.

Transaction Type—Either Standard Energy, Structured Energy, Transmission, Ancillary Services, Generator Tolling, or Real-Time.

Location—For transmission deals, the “Location To” point is displayed. For example, the location column will display Nepool for a transmission deal from for VAP-PJM Int to Nepool.

Product Type—5×16, custom, etc.

Start Date

End Date

Price Type—Index or Fixed

Price—$/MWh, or the basis value if the deal is an index deal

Volume Type—Fixed or %-of-Pool

Size—MW

Transaction ID

Position—Long or Short (i.e., bought or sold)

Position Type—Natural or Executed

Users can sort the contents of the screen by clicking on the heading of the Transaction Type, Location, Product Type, Start Date, End Date, Position, and Position Type columns as well as move the columns by grabbing them with the mouse. However, unlike the marketplace screens where each transaction type has a separate screen, all portfolio positions are viewed in the same screen regardless of the transaction type.

Users can select any single row and right click on their mouse to view details, add to the scenario tab, calculate VaR/MTM, edit parameters, duplicate positions, create hedge positions and delete positions.

The table below summarizes the functionality of these choices within the Positions tab:

| | |
|---|---|
| View details | Displays details for selected position similar to “View |
| | Details” in the marketplace |
| Add to Scenario | Add the selected position to the scenario tab |
| Show VaR/MTM | Calculate VaR and MTM of the selected position |
| Edit and Create | Modify any parameter of a position |
| Duplicate | Duplicate an existing position |
| Create Hedge | Create a hedge position for the selected position |
| Position | |
| Delete | Delete the selected position |

Once the portfolio is represented within the application of the present invention, users can calculate the MTM and VaR of their existing positions. Users can analyze the stand-alone risk of a market transaction as well as perform scenario analyses on how the MTM and VaR of their portfolio would change if certain transactions were executed. This feature enables users to perform instant risk/return analyses on any posted transactions before executing and adding the transaction to the portfolio.

When users create a hedge transaction, the application will post the transaction to the user's private portfolio. The application creates the hedge position using the same parameters as those of the natural position. However, the sign or position will be opposite of the natural position. In other words, an offer is created for a long position and a bid is created for a short position. When users elect to create hedge positions, the appropriate transaction dialog with parameters filled in with those of the natural position will appear (except for price). Users can then click on the “Submit” button to create the hedge position. Users can post the hedge position to the marketplace from their Private portfolio, which can be accessed by clicking the “View MY” button in the Marketplace.

The Positions tab has the following main functions:

Generate Position Report

Create Natural Position

MTM/VAR Report

Transaction Summary

Residual Management

These functions are discussed in detail in the next sections.

Create Natural Positions

Users can use the “Create Natural Position” button to represent positions from their existing portfolio. This feature can capture long and short Positions for all transaction types: Standard Energy, Structured Energy, Transmission, Options on Energy and Transmission, Ancillary Services, and Generator Tolling. The following is a description of an exemplary process for creating a natural position. Represent a 7×24, 50 MW, standard energy long position at COB for the calendar year 2002.

1. Click on the Create Natural Position button.

2. A dialog box will prompt you for the position type and transaction type, i.e., Standard Energy, Structured Energy, Transmission, Ancillary Services or Generator Tolling. In this example, select long for position type and: i.e. standard energy for transaction type.

3. A dialog box similar to the dialog box for posting standard energy products to the marketplace will appear. Fill out all the boxes of the dialog box. For help on filling out the dialog box, refer to the section on creating standard energy transactions.

4. Click on the submit button to enter the position to the portfolio. Similarly, all position types can be entered into the portfolio. The deal capture dialog box for portfolio management has the same exact layout as the transaction entry dialog box for the marketplace. To simplify deal entry for portfolio management, it is possible for a user to aggregate their positions by location, and product type and enter the aggregate position into the system. The aggregate representation will reduce the number of deal entries.

MTM/VAR

The risk engine of the present invention performs mark-to-market (MTM) and linear value-at-risk (VaR) calculations on a user's entire portfolio and selected positions. Users can view the MTM and VaR report by clicking on the MTM/VaR button and can also view the MTM and VaR of a position by selecting “Show VaR/MTM” from the right-click mouse menu.

The portfolio MTM and VaR calculations accounts for user's natural positions and executed trades. As a result, for users to accurately portray their natural positions, they must enter them within the positions tab. Any position that is posted to the market does not have MTM or VaR exposure; as a result, they are not included in the MTM/VaR report.

To compute MTM/VaR, users can either use provided or their own forward curves, volatilities, correlations, and price shapes. Users can enter their own data from the User Input tab, which is discussed in, User Inputs. To view the MTM/VaR report, click the MTM/VaR button. This button will create the MTM/VaR report in a separate web browser window.

Users can easily sort the report and thereby, calculate MTM and VaR by (a) Counter Party (b) Region, (c) Transaction Type, (d) Position (long or short) (e) Position Type (natural or executed). The report can be downloaded to Microsoft Excel by clicking on “Download MTM/VaR Report.”

VaR within the system and method of the present invention is defined for a one-day horizon at a given probability of 95% (two tail) and using the variance-covariance methodology. This is the default calculation. However, users can go into General Settings and change the confidence interval and VaR duration to their preferences. Based on User's preference for source of data settings in the General Settings tab, the application will either use user-defined or default forward curves, volatilities, correlations, and price shapes. The specific methodologies used are contained in the MTM/VaR Device.

Transaction Summary

A user can easily view a summary of their transactions by clicking on the “Transaction Summary” button. A user's Transaction Summary will contain all publicly posted trades, privately posted trades, and transactions bought and sold by the user. The report can be downloaded to Microsoft Excel for additional analysis.

To view the Transaction Summary report, click on the Transaction Summary button. This button will create the Transaction Summary report in a separate web browser window. Transactions can be sorted by (a) transaction ID, (b) location, (c) start date, and (d) end date. A user can download the report to Microsoft Excel by clicking on “Download Portfolio.”

This summary report also contains the details for any active linked transactions created by the user.

Residual Management

The present invention provides additional structuring tools capabilities enabling users to create hedges or offsetting transactions against any existing portfolio position(s). Users are also given the ability to manage residual positions resulting from the impact of one or more current positions. Residual positions represent net volumes, or a net market position for each location, which accounts for both the long and short positions of products at particular locations and price types. The underlying calculations to produce these results are the same that are used in the Trade Disaggregation Device. Users can calculate the risk of the residual positions, contemplate on various strategies to layoff residual risks, and post residual positions to their private portfolios. The underlying calculations to produce these results are the same that are used in the MTM/VaR Device.

For example, a user who is short 20 MW, 6×16 at COB for the first quarter of 2002 and has another position where she is long 15 MW, 6×16 at COB for the first quarter of 2002 has a residual position of 5 MW, 6×16 short at COB for the first quarter of 2002. Although this was a very simple example, if users have to combine all positions including standard energy, structured energy, transmission and generator tolling the calculation can be substantial. The residual management function of the present invention performs these calculations for the users, allows users to calculate the risk and MTM of these positions, and enables users to post their residual positions to their private portfolio, where users can transfer it to the marketplace at the opportune time. Again, the fundamental calculations and results are based on the logic contained in the Transaction Disaggregation Device.

User's can access the residual management function by checking the residual management mode box within the portfolio management, positions tab. The residual management mode will display the user's portfolio as well as private and publicly posted transactions. The reason the public and private transactions are displayed is to enable users to assess their residual position if these transactions were to be executed. Users can select the row of the position(s) and transaction(s) they want to include in the residual management calculation and click on the “Residual” button to calculate residual positions.

Users can easily calculate the risk of their residual positions by clicking “Show VaR/MTM” from the “Residual Positions” dialog box. Also, from the “Residual Positions” dialog box users can click “Create Hedge” and post their residual position to their private portfolio.

As is the case with hedge positions created from natural positions in the positions tab, residual positions can be disaggregated at the election of the user within the private tab (under “View My” in the marketplace).

The use of this feature is described in the following example wherein a user is concerned about her portfolio's exposure at PJMW and wants to create a hedge to reduce the exposure. To create a hedge she first wants to examine the residual position (net position) at PJM-PJMW Hub. Within her portfolio she has the following trades at PJM-PJMW Hub:

A short structured natural position from Apr. 1, 2002 to Dec. 31, 2002 of average size of approximately 500 MW.

A long executed structured position for the month of June 2002 of average size of 100 MW

A long standard natural position in fourth quarter 2001 of 100 MW.

The following is a description of an exemplary process to calculate the residual position; the user goes through the following steps within the portfolio management tab.

1. Check the residual management mode box within the positions tab in portfolio management.

2. Select the rows that contain the above mentioned transactions.

Note: To select noncontiguous rows, press the “Ctrl” button on your keyboard and then select the other rows.

3. Click on the residual button.

Note: Residual positions dialog box appears that lists the residual position. The user has a short position of average size of approximately 472 MW from Apr. 1, 2002 to Dec. 31, 2002.

4. To examine the details of the residual position, select the row and right click and select “Details.”

Note: The “Detailed View” dialog box is same as that in the marketplace. From this dialog box, user's can download the residual data to Microsoft Excel using the copy/paste functionality.

5. To calculate the risk and MTM of the residual position, click on the button “Show VaR/MTM”. To create a hedge, click the “Create Hedge” button.

Note; Residual positions cannot be posted directly to the public market. All residual positions are first posted to the private portfolio within the structured energy marketplace and from the private portfolio users can further disaggregate the residual position and post all or some of the disaggregated positions, post the entire residual position as is to the marketplace, or let the matching agent of the present invention find potential matches. The matching process is described in greater detail below.

Residual positions can also be added to the “Scenario Tab” where it can be evaluated against potential trades.

Scenario Analysis

The system also contains a Scenario tab, where transactions added to the scenario where single transactions, groups of transactions, or the entire group of transactions in the scenario can be fully analyzed from a risk calculations perspective. This works particularly well for incremental transactions under consideration because the current values of a negotiated transaction, for example, can be evaluated within this tab. The user also has the flexibility of viewing risk results using their own or the system's default market assumptions.

With a simple right click of a mouse, users can calculate risk of energy transactions both on a stand alone and on a portfolio basis. The on demand calculations of the present invention enable users to analyze risk before executing or posting any transaction. Users can analyze different scenarios by highlighting the rows of transactions that are of interest to them and then right click on their mouse and select “Add to Scenario” from the marketplace.

The following is a description of a scenario analysis. A user sees a 6×16, 50 MW, standard energy offer at COB for the calendar year 2002 and she wants to evaluate the stand alone risk of this transaction as well as how this transaction will change the risk of her portfolio.

1. Select the row that contains the transaction in the standard energy marketplace.

2. Right click and select add to scenario.

3.. From the Portfolio Management tab, select the Scenario tab. The selected transaction now appears in the scenario tab.

Similar to the marketplace, users can right click and view the details of the transactions.

To calculate the stand-alone VaR, users can highlight the transaction and click on the “Show VaR/MTM” button at the bottom of the screen.

Users can add multiple transactions from all the marketplaces to the scenario tab. To calculate the risks of multiple transactions, select the transactions and then click on the “Show VaR/MTM” button. Press and hold down the “Ctrl” key to select the noncontiguous rows of transactions.

To calculate VaR and MTM from a portfolio perspective, users can include their natural and executed transactions by checking on the “Natural” and “Executed” boxes on the upper right corner of the dialog box. Users can select the natural positions along with the transactions) from the marketplace and then click “Show VaR/MTM.”

Matching

The present invention contains a matching agent that expands the market by providing users additional means of satisfying their needs beyond simply scanning the marketplace for opportunities. When users create energy or transmission transactions, they can specify matching parameters for transactions posted to the marketplace or their private portfolio. There are user defined default matching parameters created within General Settings. Once matching parameters have been specified, the matching agent will continually search the marketplace for product matches, and will first notify users when matched solutions are available and subsequently as matching solution sets change.

The system automatically sends messages (within Messages tab) to users regarding match results, based solely on posted transactions. Users can also view all current matching results from the Matching tab. For matched solutions that contain transactions from potential counterparty's private portfolio, the structuring agents will work with users to suggest that matches are likely to be found if particular private transactions are posted.

A user's private transactions are never revealed to other market participants. Only E-lecTrade structuring agents have the ability to utilize the matching technology information to process results based on the public and private marketplace. As a result, the structuring agents are able to view matching results for public to public, private to public and even private to private solution sets. This is the basis for the structuring agents to be able to suggest to users regarding potential matches for private transactions.

Users can only view matching results for transactions that have been publicly posted. All transactions must be completed from the public marketplace. The execution of transactions from the marketplace ensures proper price discovery. .

At any time, users can view matching results for a particular transaction by highlighting that transaction in the matching tab. Alternatively, users in the marketplace tab can go to the Marketplace, or the “View My” template, highlight the transaction and then click on the “Matches” button.

Users can get a summary of ALL of their matching results by clicking on the Matching Summary Report button within the Matching tab. Users specify several parameters for match criteria that will be used to search for possible matching products. Users can specify such parameters as:

Basic matching criteria

Minimum thresholds for total percentage volume matched;

The total number of transactions that, in combination, constitute a matched product to a posted bid/offer;

Whether matched transactions can include energy products at other locations with available transmission;

Minimum contributions from individual transactions that are part of a matched solution set; and

Percent utilization range for a transaction as potential matches to appear in solution sets of other users.

The system scans supply and demand on a continuous basis and creates optimized matches based on the objectives and criteria/constraints stipulated in counter-parties' portfolio and constraint/criteria. Matching results produced will be highly dependent on the transaction created how the tolerance bands for matching parameters. For example, the originator of a structured product may specified that matching results meet the following criteria:

Matching sets must satisfy at a minimum at least 50% of the volume (on a cumulative hourly basis) that has been specified in the original transaction.

Matched sets may contain no more than three transactions in the solution set (excluding transmission transactions).

No individual transaction in a matched group may contain less than 10% of the volume (on a cumulative hourly basis) that has been specified in the original transaction.

Energy from an adjacent location where there is sufficient, posted transactions for transmission is acceptable.

Transactions that are financially settled are acceptable.

An acceptable utilization range (% of posted transaction) of the transaction to be considered in the match solution sets of other users is 60% to 110%.

After creating a transaction, the user needs to highlight that transaction, and right click to view the matching parameters template. Once matching parameters are specified, these values do not change unless changed by the user. However, if a user edits or duplicates a transaction, the matching parameters are lost and new values must be created. If a transaction is withdrawn and then reposted, the existing matching parameter values are retained.

In: this illustration, matching results for a specific transaction are displayed. The primary information fields are:

Description—Designates the contents of that row (original transaction, the matching transaction(s) or the summary)

Rank—Solution rank. Display may contain up to the best five solutions, with “1” being the solution with the highest (or best) ranking.

Transaction ID—the unique ID of the described transaction.

Start date—First day of transaction term

End date—Last day of transaction term

Region—Marketplace region

Location—Marketplace location

Transaction type—“Power” for Standard and Structured Energy, or “Transmission”.

% Utilization—percent volume of matching transaction that is used for the specific match solution.

Cost/value—contract cost/value, consistent with % utilization.

% Volume match—stand alone % volume match contribution of matching transaction compared to the original transaction.

Residual volume—The total Mwh mismatch that would occur if the matching transaction on a stand alone basis were executed to offset the original transaction

Residual Cost/Value—contract cost/value associated with the residual volumes, where the residual volumes are based on the stand alone matching transaction against the original transaction.

VaR—The VaR associated with the residual volumes.

Total % volume match—This result is shown only in the SUMMARY row level, representing the residual volume assuming all matching transactions are executed against the original transaction.

Volume Satisfaction %—Total % volume of the original transaction that is fulfilled by the matching transactions. Hourly volumes exceeding those required in that hour per the original transaction are treated as being 100% satisfied for that particular hour.

When viewing matching results for a particular transaction, the user can utilize some functionality that is generally accessed through the marketplace tab.

Specifically, transaction details can be viewed, and negotiations can be launched from within the matching results template. The logic and calculations for matching were discussed in the Transaction Matching and Syndication Device section.

User Inputs

The user input tab captures users' transmission losses, forward price, volatilities, price shape, and correlation data. Users have the option of using either their own or provided data for MTM and risk analyses. For users to use their own data, they must enter that data in the user input section. The following is a description of entering a user inputs:

Transmission Losses

Users can define Transmission Losses in the User Input tab. Transmission losses are defined for two points at a time. For example, to define transmission losses between Palo Verde and SP15, first select Palo Verde for the “From” location and then select SP15 for the “To” location. After selecting the two points, enter the losses for the entire 12 months and click on the “Submit” button. To view previous entry for losses, select the two points and click on the “View” button. To clear the screen simply click on the “Clear” button.

Note: To delete any previous data entry, enter new data and click on the “Submit” button. To enter value of zeros, first click on the clear button and then click on the “Submit” button. Also, if losses have been specified from location A to location B, the assumed losses from location B to location A is the inverse, and must be treated that way for consistency of results. Therefore, losses will be negative in one direction.

Transmission losses affect the matching solutions, MTM/VaR calculations, and residual positions. When users allow transmission deals to be included for matching, the matching engine will adjust the amount of energy to account for user-specified losses in calculating matching solutions. Likewise, the MTM/VaR calculation and residual volume calculations will account for short positions that result from transmission losses. For example, suppose a user defined transmission loss between COB and NP15 of 5%. Also, suppose the user bought 40 MW of physical transmission from COB to NP15. The application of the present invention will account for the transmission loss as short 2 MW at NP15. Transmission deals are represented as long and short energy positions. For the above example, the user would have a short position of 40 MW at COB and along position of 38 MW at NP15 (40 MW less 2 MW of losses). For users to account for transmission losses in matching solutions, MTM/VaR calculations, and residual volume calculations, users must specify transmission losses. The default transmission loss setting in the system is zero for all locations other than PJM, where published, static loss values are available and used. However if no losses have been defined by the user, then default losses for all other locations are zero.

Forward Curve and Volatilities

Users can input and view their own forward curves and volatilities as well as view the provided forward curves and volatilities from the Forward Curve and Volatilities tab, respectively. Users have two choices for viewing and uploading data. They can upload data directly from the dialog boxes or they can download or upload data using Microsoft Excel. For example: A user wants to input forward curves for Oct. 3, 2001 for all locations.

1. Click on the “Input” button in the Forward Price tab.

2. In this example, enter the date: Oct. 2, 2001

Note: The current month, October, is represented in two parts, balance of week (BOW) and balance of month (BOM). BOW, in this example, is from Tuesday, October 2, to Sunday, Oct. 7, 2001 and BOM is the remaining days of the month.

A week, for the purpose of this description is considered to end on a Sunday or the last day of the month if the last day is different from Sunday. The starting day for BOW changes at 10 a.m. For example, before 10 am on Tuesday, October 2, BOW starts from Tuesday. However, after 10 am the same day, BOW starts from Wednesday, October 3. The application will interpret the starting day for the data entered for BOW before 10 am to include the current day and the starting day for the data entered after 10 am to not include the current day. These definitions for BOW and BOM are consistent with how these products are traded within the marketplace.

3. The user can enter the data either in the template displayed on the screen or can click on the “Upload” button to enter the data using Microsoft Excel. The “Refresh” button will clear any existing data on the screen, and the “Copy” button can be used to download any existing data to Microsoft Excel, which can also be modified and then submitted to the application.

4. The user then opens Excel and pastes the template and values which have just been copied. The user populates updated data into Excel, then copies this data.

5. Going back to the forward curve template for the system, the user hits the “Paste” button to import the values just updated in Excel. After being pasted, the updated values can be submitted to the system database by hitting the submit button.

Price Shapes

Price shapes are used by to derive the hourly forward prices from the monthly forwards entered in the forward price tab. Price shapes are defined for each month based on a typical week pattern for both peak and off-peak periods and are normalized values where the maximum value is one for one or more hours. In other words, the hour with the highest price will have a value of one and the rest of prices will be relative to the highest price.

Note: Price Shapes can be calculated by going through the following two steps:

1. Price Shapes are represented for typical week of each month for peak and off-peak periods. One way to derive typical week shape is to group the data by days of the week and take the average for each day of the week. In other words, take the average of all the Mondays, Tuesdays, and so on. Alternatively, users may pick a representative week for each month from the data. Users may use one or more years data to calculate price shapes.

2. To derive the peak price factors, divide the expected hourly peak prices for each day of the typical week by the maximum peak price of the typical week. Likewise, to derive the off-peak price factors, divide the hourly off-peak prices for each day of the week by the maximum off-peak price of the typical week. The result should be a series of normalized price shape factors where the maximum value is 1.0, corresponding to the highest price hour for each monthly subperiod.

Price shapes are used to derive the hourly forward prices from the monthly forwards by multiplying the monthly forward price by the price factor for a particular hour divided by the average of all price factors for the month. In other words, to derive the forward price for hour 1, June 2001, the application of the present invention will multiply the June 2001 forward price by the price factor for hour 1 divided by the average of the price factors. (Note: Hour 1 is in the off-peak period; therefore, the application will divide by the average of the off-peak price factors for the month.)

Users have some flexibility on how they can enter the data. This flexibility is similar to that of entering data for correlations. Users can enter price shapes at two different levels of detail: by regions or by selected locations.

Price Shapes by Region

At the simplest level, users can specify a price shape by region. Each region contains a template for capturing peak and off-peak prices. All locations within that region will use the same price shape.

As is the case with all user inputs, users have a choice of either entering the data directly in the dialog box or entering the data using Microsoft Excel. To enter data using Microsoft Excel, click on the “Upload” button. The steps to entering the data are similar to those of entering the forward price curve.

Users must enter a price shape for each of the calendar months. If the price shape is same for all the months, then click and check the box “Apply January Profiles to Other Months.”

Price Shapes by Selected Locations

With this selection users have complete flexibility to select locations for which they wish to create price profile data. Users can define detail shapes for locations of their choice and default to regional level detail for other locations. For example, the user can define a specific price shape for NP15 and default to regional level price shapes, entered at the regional level, for all other locations in the West.

Note: For each location selected, the user must enter a peak and an off-peak price shape.

If Price Shapes are entered in at this level, they take precedence over Price Shape information entered at the Region level. If a user has not entered in any price shapes, then the default is that all price factors are equal to 1.0 for all hours in the subperiod (which is the same as a flat price or the same price for all hours in the subperiod).

Correlation

Users can enter their own correlation matrices in the correlations tab. Similar to price shape data entry, users have flexibility in choosing the level of detail they want for entering data. Users can input data at the Macro level, at the detailed level by time spreads, and at the detailed level by proxy product specific correlations.

Macro Level

The macro level is the simplest level of data entry in that there is minimum amount of data entry required. In this case, the user simply provides a correlation coefficient value that the system can use for ALL products meeting the specified criteria. At the Macro level the user does not need to enter any location specific correlation data.

The Macro level matrix is divided into two components: the inter-regional correlations and the intro-regional correlations. Enter the appropriate correlations for all the fields in the template.

Detail Level

The two forms of detail level inputs are by selected location and require the user to define a matrix of correlation values at monthly resolutions.

One detail level for data requirements is region/location specific by time spreads. Here, a user populates a correlation table for each identified combination of locations/products, from one to sixty months. In this arrangement, the correlation between two products, say June 2004 to August 2004 is the same as April 2003 to June 2003 because the time spread of two months is the same in both cases.

A second detail level for data requirements is region/location specific by proxy product. This is the most detailed approach, where an entire correlation matrix is defined for each combination of proxy products.

In using User-Defined correlation data, the system first looks for data at the region/location specific by proxy level. If any information is specified, this is used. If no data is entered at this level, then the system looks for data at the region/location specific by time spreads. If any information is specified here, then this is used. If no data is entered at this level, then the system looks for data at the macro level. If any information is specified here, then this is used. Finally, if no correlation data is entered at all of these levels, the system uses default values of zero.

Exemplary Transaction Overview

Basic Transaction

In an exemplary transaction utilizing the present invention a user can execute a transaction through the completion of the following steps. The steps are exemplary and are valid for a transaction that does not necessarily require a negotiation session.

1. On the main window, the user selects the Marketplace tab, and within Marketplace, clicks on the Standard Energy tab. Transactions in the marketplace are displayed, one transaction per row unless there are bids and offers for the same product.

2. The user is presented with a posted Standard Energy bid for a 5×16 product at PJMW, period is first quarter 2002, price is $40.00/MWh and size is 55 MW.

3. The user wishes to execute this transaction, highlights that row, right clicks to “sell” and says “yes” to the question about being sure about selling this transaction as posted. This transaction qualifies in that both parties have credit with one another and the ability to execute the particular transaction type.

4. The transaction is executed. Both users receive a notification email from the system that displays the details of the executed transaction and the identity of the other counterparty.

In this illustration, there was no negotiation, no request for structuring tool analytics, no risk calculations, etc. Therefore, no background calculations were necessary as part of the deal execution process. The following transactions described below are presented for the purpose of describing those additional features of the present invention.

Standard Energy Transactions

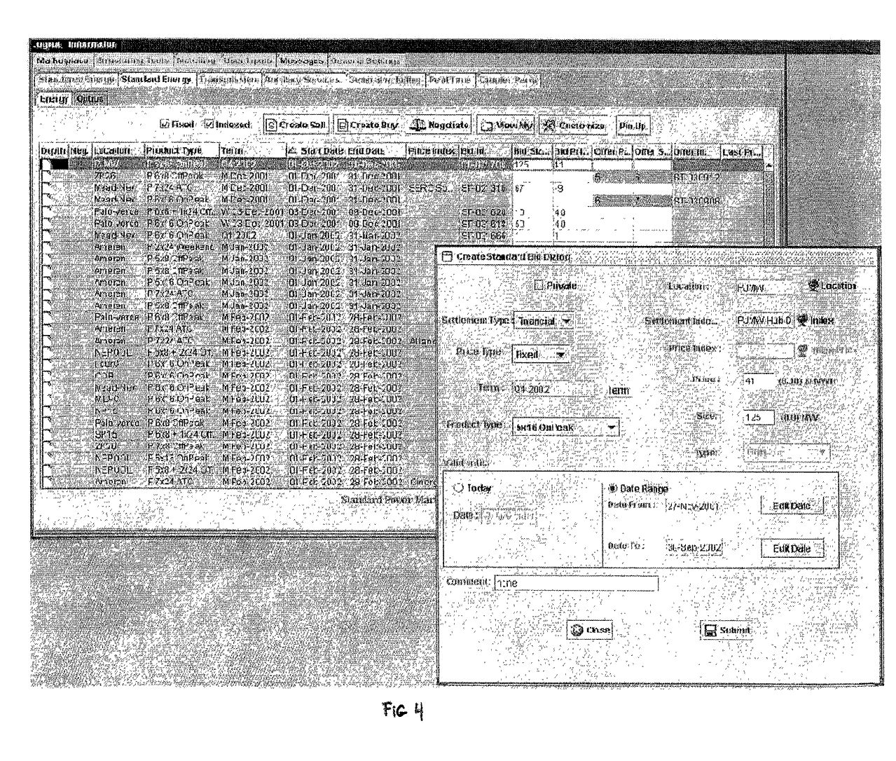

The present invention provides users with a market for buying and selling standard blocks of forward market energy. Turning now to FIG. 4, there is shown an exemplary web page window depicting a screen for a Standard Energy Marketplace Users have the flexibility to post bid/offers for standard block products such as peak (5×16 or 6×16), off peak, and around the clock (7×24). The product term can range from next day through annual and out to five years. While the structure of the products is standard (i.e. 5×16 or 6×16), there is no standard MW size. All products are firm.

Example: A user wants to post to the market a bid for a financial swap at PJMW at a fixed price of $41/MWh for 125 MW, OnPeak, fourth quarter 2002 product settled against the PJMW Hub, daily day ahead LMP.

1. Within the Marketplace tab, select the Standard Energy tab

2. To create a standard bid, click on “Create Buy” button (similarly, standard offers are created by clicking the “Create Sell” button). The “Create Bid Dialog” box provides users with flexibility in defining the terms of the standard product. The first selection “Private” enables users to post transactions to either their public or private portfolios. If this box is selected, then transactions will only appear in the user's private portfolio and will not be posted on the market.

3. In this example, the user wants to post the bid to the market; therefore, does not select the private box. The next selection choice is Location. Users can select the location of the transaction from a drop down menu by region first and then by specific locations within that region. To select PJM-PJMW Hub, first select the Northeast market from the drop down menu and within Northeast, select PJM-PJMW Hub.

4. The next selection is Settlement Type, which can be physical or financial. Note: A fixed price transaction that is financially settled is effectively a financial swap. In this example, the user wishes to define a financially settled transaction.

5. For all financially settled transactions, a specific settlement index must be selected. In this example, the user wants to settle against the PJM-PJMW Hub, Daily Day-Ahead LMP.

6. The price type can be either fixed or indexed. For fixed priced deals, the price is expressed in $/MWh terms, and for indexed deals, the price field captures the basis relative to the defined index, which is specified in the Price Index field. In this example, the user is interested in a financial swap, which as noted above is the same as a fixed priced financially settled product. In the price field, the user enters $41/MWh, in the size field, the user enters 125 MW. Note: If the user were interested in an index deal, the user would have to select an index in the price type field and would have to specify an index in the Price Index field. For index deals, users have to specify a basis value to the selected index. The basis value can be captured in the price field, which will be relabeled basis.

Users can have physical deals at one location but indexed to a different location, such as physically at PJMW but settled against PJM-PJME Hub prices.

For all financially settled deals, the “Settlement Index” is relevant from a market position and risk perspective as opposed to the specified Location of the deal. Because financial deals are settled against the “Settlement Index,” location of the deal is irrelevant. However, note that deals in main window are posted by the location, and as a result, for transactions you create make the location reflect the effective location.

7. The user is interested in a fourth quarter 2002 product. In the term field, user selects Q4 2002 from the drop down menu.

8. In the product type field, the user selects 5×16 peak from the drop down menu.

9. The “Valid until” section at the bottom of the screen is used to define the period for which the counterparties can either buy/sell the posted product, or initiate a negotiation process. The choices are today only, or a user defined “Date From” and “Date To” range.

10. Post the bid to the marketplace by clicking the submit button at the bottom of the dialog box.

As the transaction is created, the user is prompted with a matching parameters template, requesting that the user specify the terms and conditions for this transaction to be matched by the system's matching algorithms. How a user defines these conditions and how the system then performs calculations for matching is discussed in the “Transaction Matching/Syndication Device” section.

Transmission Transactions

The present invention provides users with a market for buying and selling standard blocks of transmission. The structure of the Transmission market is very similar to that of the standard energy market. Users have the flexibility to post bid/offers for both point to point and network transmission markets in standard product terms such as peak (5×16 or 6×16), off peak, and around the clock (7×24). The product term can range from next day through annual and out to five years. While the structure of the products is standard (i.e. 5×16 or 6xl 6), there is no standard MW size. All transmission products are firm.

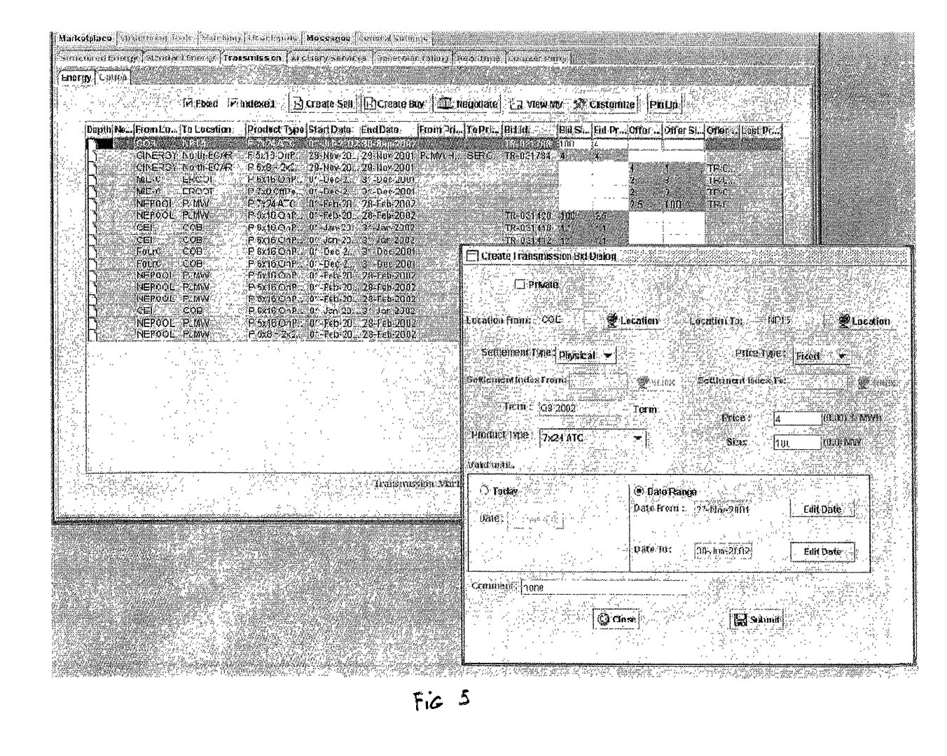

Turning now to FIG. 5, there is shown an exemplary web page window depicting a screen for an exemplary transmission transaction.

A user wants to purchase 100 MW, around the clock (7×24) firm transmission rights from COB to NP15 for third quarter of 2002 for $4/MWh.

1. Within the Marketplace tab, select the Transmission tab.

2. To create a standard bid, click on “Create Buy” button (similarly, standard offers are created by clicking the “Create Sell” button).

Note: The “Create Bid Dialog” box provides users with flexibility in defining the terms of the standard product. The first selection “Private” enables users to post transactions to either their public or private portfolios. If “Private” is selected, then transactions will only appear in the user's private portfolio and will not be posted on the market. A user's private portfolio can only be seen by the user and by the matching agent of the present invention.

3. In this example, the user wants to post the bid to the market; therefore, do not select the private box. The next step is to specify the two location points of the transmission deal. Users can select the location from a drop down menu by region first and then by specific locations within that region. In this example, user must select COB for “Location From” and NP15 for “Location To.”

4. The next selection is Settlement Type, which can be physical or financial.

Note: A financially settled product could easily be replicated by taking positions at the two points of transmission. For example, a financially settled long position at NP15 and a financially settled short position at COB can replicate the same payoffs as a financially settled transmission product. In calculating risk of transmission products, the present invention represents transmission products as long or short energy positions at two locations.

5. The price type can be either fixed or indexed. For fixed priced deals, the price is expressed in $/MWh terms and for indexed deals, the price field captures the basis relative to the defined index, which is specified in the Settlement Index fields. In this example, the user has to enter fixed in the price type field and $4/MWh in the price field. However, it should be noted that if the user were interested in an index deal, the user would have to select an index in the “Settlement Index From” and “Settlement Index To” fields. For index deals, users have to specify a basis value to the difference between the selected indices. The basis value can be captured in the price field, which will be relabeled basis. For indexed deals, the value of transmission is equal to the difference between the “Settlement Index From” and the “Settlement Index To.”

Note: For transmission, if a transaction is specified as financially settled, the price type must be fixed.

6. The user is interested in a third quarter 2002 product. In the term field, select Q3 2002 from the drop down menu.

7. In the product type field, the user selects 7×24 from the drop down menu.

8. In the size field, type 100 MW.

9. The “Valid until” section at the bottom of the screen is used to define the period for which the counterparties can either buy or sell the posted product, or initiate a negotiation process. The choices are today only, or a user defined “Date From” and “Date To” range. A user can delay the posting of a transaction by specifying a future date in the “Date From” field. Users can view such postings by clicking the “Future” button in the “View My” screen. Also, at any time, users can immediately withdraw posted bids or offers by highlighting the particular transaction and hitting “Withdraw” on the “View MY” screen.

10. Post the bid to the marketplace by clicking on the submit button at the bottom of the dialog box. After clicking on the submit button, a dialog box will appear to inform the user that the transaction is successfully completed. The transaction will appear as a new line in the main screen. If another transaction had the same location, term, and product then the posting would be grouped with that transaction. The transaction can be displayed on a new row by clicking on the folder symbol in the depth field. If, on the other hand, an offer existed with similar terms, then the new posting would appear on the bid side of the screen as opposed to a new row.

As the transaction is created, the user is prompted with a matching parameters template, requesting that the user specify the terms and conditions for this transaction to be matched by the system's matching algorithms. How a user defines these conditions and how the system then performs calculations for matching is discussed in the “Transaction Matching/Syndication Device” section. For transmission, the relevant parameters are utilization percentage ranges because transmission deals are components of matching solutions, and no matching results are produced for transmission deals directly.

Real Time Transactions

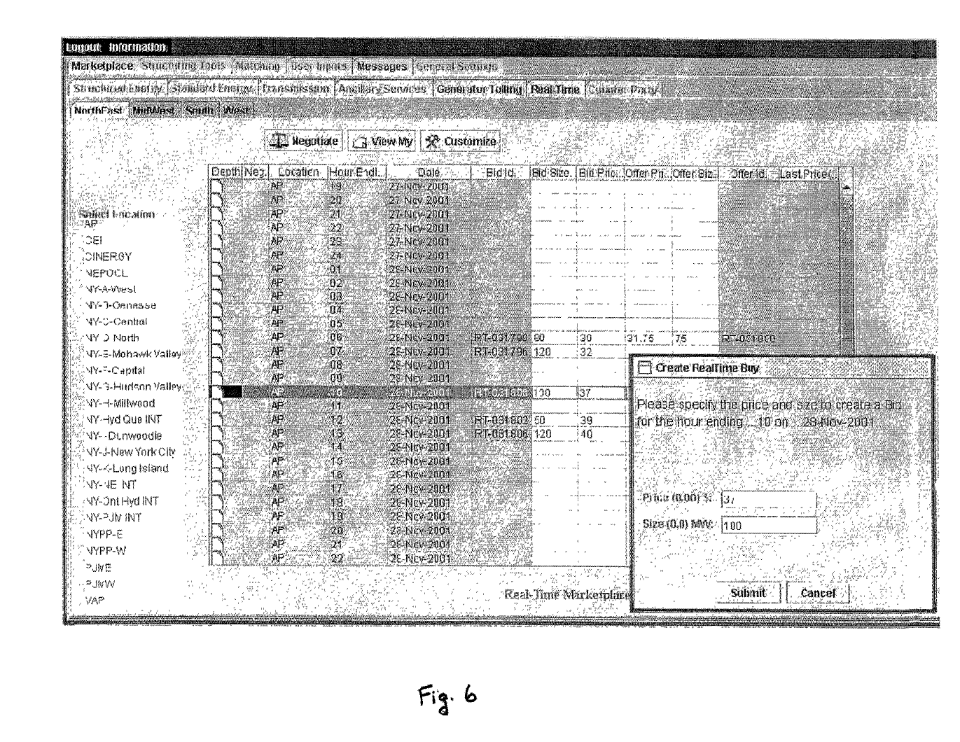

Turning now to FIG. 6, there is shown an exemplary web page window depicting a screen for a Real Time Energy Marketplace wherein users can buy and sell hourly energy blocks for the next 48 hours using the present inventions Real time market. The structure of the Real time market is similar to that of standard energy and transmission markets.

On the main screen the user can view the location of the deal, the traded hour, the date of transaction, and the bid/ask price and size. The market or main screen for Real time energy is separated by region tabs, (Northeast, Midwest, South, West) and then by particular location within each region. For example, to view the real time energy market for PJMW, first select the Northeast tab and then the select the location by clicking on “PJMW” in the Select Location field.

As with the main screens for other markets, the last price column represents the price of the last transaction for that particular product executed in the system. The first field “Depth” will display a folder if there are multiple bids and offers for the same product, and users can view additional details for a particular posting, negotiate, buy, sell, withdraw, edit, and duplicate transactions by right clicking on their mouse.

With respect to FIG. 6, the following is a description of a real time transaction. In the following example a user wants to post a bid of 100 MW for hour ending 10 at PJMW at a price of $37/MWh for Nov. 28, 2001.

1. On the main window, click on Real Time Energy.

2. To create products in the Real time market, right click on the row and field for the desired hour ending, the date, and location. In this example, click on the Northeast tab and select PJMW for location.

3. Select the row for hour ending 10 and a date of October3, 2001, and right click on the mouse.

4. From the choices, select Create Bid/Offer.

5. Enter 100 MW for size and $67/4Wh for price in the dialog box.

6. User submits transaction by hitting button in template.

Ancillary Services Transactions

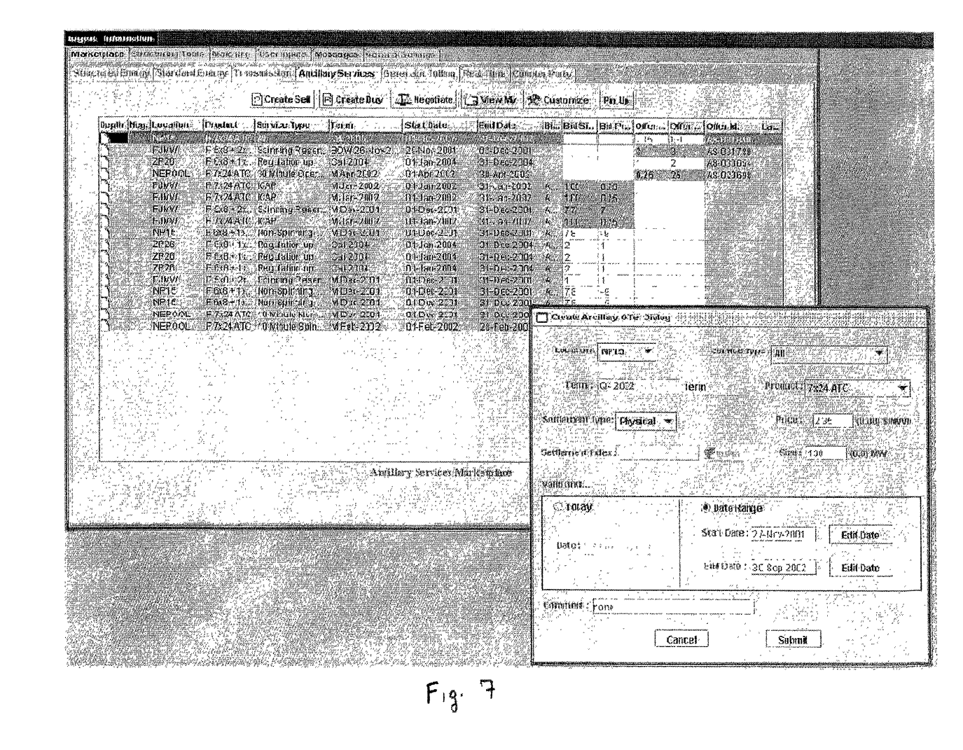

Turning now to FIG. 7, there is shown an exemplary web page window depicting a screen for a Ancillary Services Transaction, wherein users can buy and sell standard blocks of ancillary services. These standard products include peak (5×16 or 6×16), around the clock (7×24) and various off peak products. The product term can range from next day through annual and out to five years. While the structure of the products is standard (i.e. 5×16 or 6×16), there is no standard MW size.

With respect to FIG. 7, the following is a description of an exemplary ancillary services transaction. The following describes the actions a user would take a user wants to post to the market a round the clock offer for all ancillary services required for NP15 market for fourth quarter 2002 at a price of $2.35 and size of 130 MW.

1. On the main window, click on Ancillary Services tab.

2. To create an offer, click “Create Sell” button (similarly, bids are created by clicking the “Create Buy” button. The “Create Bid Dialog” box provides users with flexibility in defining the terms of the standard product.

3. The next selection choice is Location. Users can select the location of the transaction from a drop down menu by region first and then by specific locations within that region. To select NP15, first select the Northeast market from the drop down menu and within West, select NP15.

4. In the Service Type field, the user needs to select the ancillary service. In this example, the user wants all the required ancillary services for the NP15 market. Note: The trading for ancillary services market currently exists for PJMW, NEPOOL, NP15, SP15 and ZP26. The table below displays the types of services traded for each of these markets. The selection “all” applies to all the traded ancillary services for a particular market

5. Select fourth quarter 2001 for the term of the deal.

6. For product type, select 7×24 ATC.

7. As with other standard transactions, the settlement type can be physical or financial.

8. Prices are expressed as dollars per MWh. In this example the user needs to enter $2.35/MWh. Prices for all ancillary services are fixed only and expressed as dollars per MWh, including prices for ICAP (where ICAP is applicable).

9. The settlement index is always the respective ISO clearing prices for each of the markets.

10. The “Valid until” section at the bottom of the screen is used to define the period for which the counterparties can either buy/sell the posted product, or initiate a negotiation process. The choices are today only, or a user defined “Date From” and “Date To” range.

11. Post the offer to the marketplace by hitting the submit button at the bottom of the dialog box.

Structured Energy Transactions

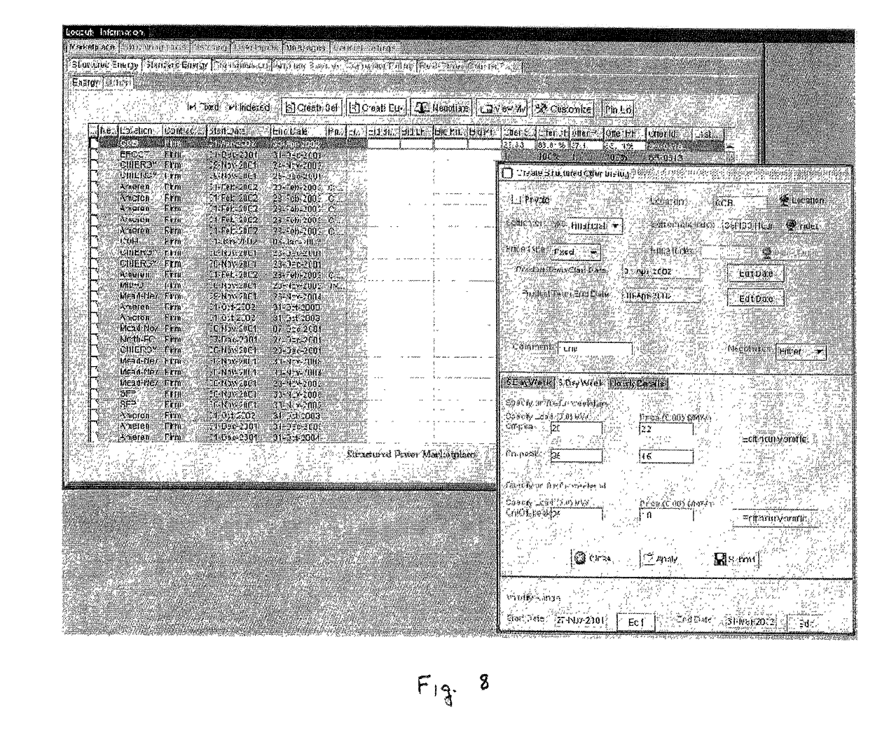

The present invention provides users with the ability to buy or sell structured energy products. Structured energy products are custom designed to suit the individual needs of users. Users can structure energy products to the hourly level detail by submitting hourly load and price shapes. Turning now to FIG. 8, there is shown an exemplary web page window depicting a screen for a Structured Energy Marketplace. As shown in FIG. 8, there are displayed data fields for a plurality of transaction information, these include the same fields displayed for standard products, together with additional fields named “Bid LF”, “Bid PF”, “offer LF”, and “offer PF”. For structured transactions, it is important to understand the underlying price and volume shapes. These additional parameters provide some understanding of the shapes. “Bid LF” refers to the load factor (average usage/peak usage) of the load shape for the posted bid. Likewise, “Offer LF” refers to the load factor of the offer load shape. The “Bid PF” and “Offer PF” (weighted average price/maximum price) refers to the shape of the price curve. A 100% “Bid PF” or “Offer PF” means that the price curve is flat; in other words, prices for all hours are same. When a transaction is created, the effective Bid/Offer LF and Bid/Offer PF are automatically calculated and displayed in the row of data describing the transaction. See Definitions section above. Note: For structured products, there are no “buy” and “sell” buttons. To buy or sell structured products, users must negotiate on any posted transaction by clicking the “Negotiate” button.

For structured transactions, viewing the product details often becomes necessary because only limited information can be interpreted from the single row summaries in the marketplace screen. To view transaction details, right click on the mouse and select details. Because structured transactions contain data at the hourly resolution, even right click detail view information is limited. A user can view charts and tables with hourly data by clicking the plot button at the bottom of the “detailed view window” dialog box.

The following is an example of a structured energy transaction. A user wants to post to the market a bid for the following load and fixed price shape at COB for April, 2002, and wishes it to be financially settled.

Monday through Saturday

| | |
|---|---|
| 20 MW Off Peak | $22/MWh |
| 35 MW Peak | $45/MWh |
| Sunday | |
| 25 MW | $18/MWh |

The user is willing to negotiate all terms of the posting or just price and size and the settlement type is financial. .

1. Within the Marketplace tab, user selects the Structured Energy tab.

2. To create a bid, user clicks on the “Create Buy” button (similarly, offers are created by clicking the “Create Sell” button).

Note: As was the case for standard energy, a fixed price transaction that is financially settled is effectively a financial swap (see 3.1 Standard Energy Transactions). This transaction is financially settled.

6. For all financially settled transactions, a specific settlement index must be selected. In this example, the user wants to settle against the Cal ISO hourly market.

Note: For all financially settled deals, parties should pay attention to the “Settlement Index” as opposed to the Location of the deal. Because financial deals are settled against the “Settlement Index,” location of the deal is irrelevant. However, note that deals in main window are posted by the location and as a result, transactions are posted according to the specified location.

7. Select the term of the product by clicking on the “Edit Date” buttons. In this example, the start date is Apr. 1, 2002 and the end date is Apr. 30, 2002.

8. The price type can be either fixed or indexed. For fixed priced deals, the price is expressed in $/MWh terms and for indexed deals, the price field captures the basis relative to the defined index, which is specified in the Price Index field. In this example, the user is interested in a fixed price deal; and therefore, selects fixed in the Price Type field. If the user is interested in an index priced deal, the user would have to select index in the price type field and would have to specify an index in the Price Index field. For index deals, users have to specify a basis value to the selected index. The basis value can be captured in the price field, which then is relabeled as a basis price in the template.

9. As with all other products, users can post transactions to either their public or private portfolios. If private portfolio box is selected, then transactions will only appear in the user's private portfolio and will not be posted on the market. In this example, if the user wants to post the bid to the market; the user would not select the private box.

10. For structured transactions, users can specify the type of negotiation, “basic”, where price and size are negotiable, “flexible”, where start/end dates and price/volume shapes are also negotiable, or “either”, where the other counterparty can select whether the negotiation is flexible or basic. In this example, the user is willing to negotiate either way, basic or flexible; therefore, selecting “either” for negotiation type.

11. Users have two choices for entering load and price shape data. If the volume and price patterns are repetitive, using the typical weekday (5 or 6 day peak week) pattern makes the most sense. Prices and volumes are specified at the subperiod level only (peak vs. off-peak). Once applied, the subperiod patterns can be modified at the hourly level, however, the end result are weekly patterns that repeat for the duration of the transaction.

11. For the more complex transactions (non-repetitive volume or price shapes), users are more inclined to use the “Hourly Details tab” option. This enables users to quickly upload and download data into Microsoft Excel, using the copy/paste functions to import the hourly volumes and prices in and out of the system. When, the user selects this button, he is prompted with the message about downloading an existing profile. This request refers to the possibility that detailed hourly transaction data already exists. Whether hitting yes or no, a system template then appears which contains a copy button, allowing its contents to be copied into Excel. The appropriate column and row headings (hours and date range) are automatically created. The user populates the spreadsheet with its detailed hourly data (volumes and prices). Then these values can be copied back into the system by copying from Excel and then clicking on the Paste button in the system. At that point the hourly detailed information has been specified, although the transaction itself has not yet been submitted (downstream steps).

12. The “Valid until” section at the bottom of the screen is used to define the period for which the counterparties can either buy/sell the posted product, or initiate a negotiation process. The choices are today only, or a user defined “Date From” and “Date To” range. Note that for structured energy transactions, the “Date To” is one day prior to the start date of the transaction.

13. Click on the “Apply” button to override any existing shapes you may have in the system.

14. Post the bid to the marketplace by clicking the submit button.

As the transaction is created, the user is prompted with a matching parameters template, requesting that the user specify the terms and conditions for this transaction to be matched by the system's matching algorithms. How a user defines these conditions and how the system then performs calculations for matching is discussed in the “Transaction Matching/Syndication Device” section.

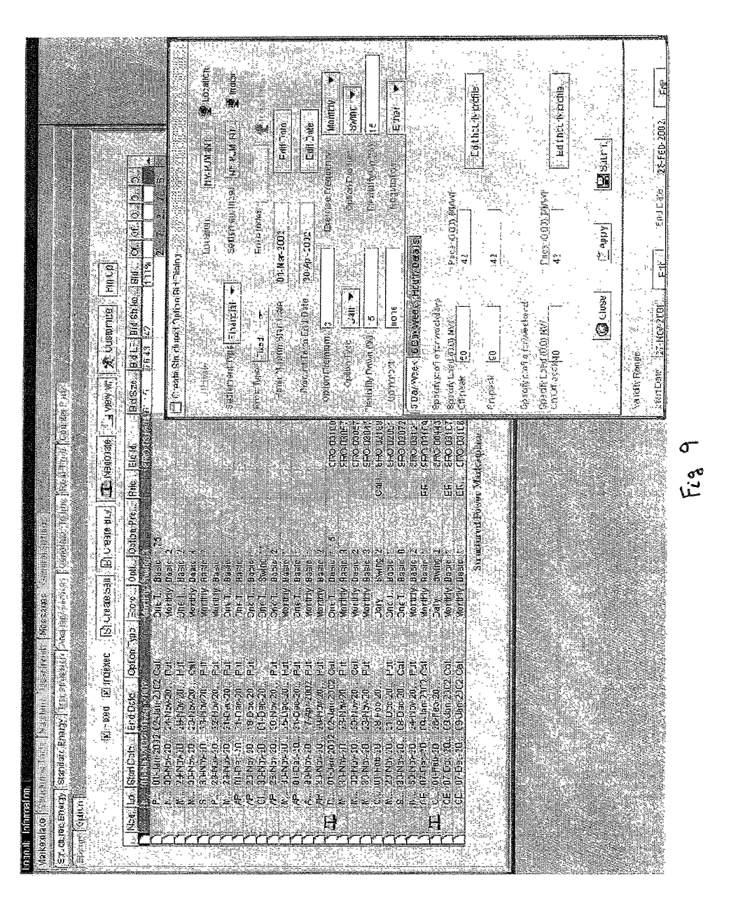

Options on Standard and Structured Energy and Transmission—The present invention enables users to create and negotiate option transactions. The product definitions are the same as the underlying standard and structured energy, and transmission transactions, however option parameters are also specified to make the transaction complete. Turning now to FIG. 9, there is shown an exemplary web page window depicting a screen for the Marketplace for an Option on Structured Energy.

In this example, the user wishes to purchase a swing option, where a plus or minus flexibility of 15% is desired on a shaped energy product at NY-PJM Interface from Mar. 1, 2002 through Apr. 30, 2002. The transaction is physical, the strike price of $42 is fixed, and the option premium is $3/Mwh. The volume shape is 80 MW peak, 50 MW off-peak on the weekdays, and 40 MW off-peak on the weekends, for all the hours in each subperiod. The user is willing to negotiate the transaction on a basic or flexible basis.

Note: For all option products, there are no “buy” and “sell” buttons. To buy or sell any option, users must negotiate on any posted transaction by clicking the “Negotiate” button. The negotiable parameters are identical to those of the underlying product, be it energy or transmission, and also the option premium (VaR/Mwh).

1. Within the Marketplace tab, user selects the Structured & Options tabs.

2. To create a bid, user clicks on the “Create Buy” button (similarly, offers are created by clicking the “Create Sell” button).

6. For all financially settled transactions, a specific settlement index must be selected. In this example, the user wants to settle against the NY-PJM Int, daily day ahead LMP.

7. Select the term of the product by clicking the Edit Date buttons. In this example, the start date is Jan. 1, 2002 and the end date is Feb. 28, 2002.

9. For structured transactions, users can specify the type of negotiation, “basic”, where price and size are negotiable, “flexible”, where start/end dates and price/volume shapes are also negotiable, or “either”, where the other counterparty can select whether the negotiation is flexible or basic. In this example, the user is willing to negotiate either way, basic or flexible; therefore, selecting “either” for negotiation type.

In the field for option premium, the user enters $3/Mwh.

In the field for exercise frequency, the user can select from one time, monthly or daily. In this example the user selects monthly. The specific dates that the option can be exercised are provided in the documentation segment of the application.

In the option product field, the user can select from basic,swing or lookback. In this example, the described product is a swing option.

In the flexibility down and flexibility up fields, the user inputs 15% for each.

10. For structured products, Users have two choices for entering load and price shape data as described above. In this example, the users load and price shape can be entered using the typical 6-Day week pattern. As a result, the user enters 50 MW in the Off peak box, $42/MWh in the Off peak price box, 80 MW in the On peak box, and $42 in the On peak price box. For Sunday profile, the user enters 40 MW for load and $42/MWh for price in the weekend profile section of the dialog box. There is no need to modify or edit hourly values here since the prices and shapes do not differ within a particular subperiod.

12. The “Valid until” section at the bottom of the screen is used to define the period for which the counterparties can either buy/sell the posted product, or initiate a negotiation process. The choices are today only, or a user defined “Date From” and “Date To” range. Note that for structured energy options transactions, the default “Date To” is one day prior to the start date of the transaction.

13. Click on the “Apply” button to overnide any existing shapes you may have in the system.

14. Post the bid to the marketplace by clicking the submit button.

During this entire process, there is no calculation involved other than what is required to define the underlying structured energy product. These are the same calculations discussed for structured energy products. The present invention does not measure the risk associated with option transactions, so no additional calculations are necessary for options.

Generator Tolling Transactions

The present invention enables generators and their counterparties to create and negotiate tolling arrangements. In this example the tolling transaction represents an exchange of gas at a particular location for electricity at a particular location. The volume of gas inputs and the volume and timing of electricity outputs are predetermined by a negotiated conversion rate and specific dispatch parameters for the electricity. However, it will be apparent to one skilled in the art that the exemplary tolling transaction could be modified for use in trading a variety of commodities and products.

The most typical tolling deal involves a generator willing to use its facility for tolling, represented as a tolling offer.

Parties have flexibility in structuring tolling agreements. Flexibility includes: 1) defining energy as either fixed or flexible each month; 2) generator availability factor thresholds; 3) electricity scheduling requirements; and 4) generator nonperformance penalties. The basic negotiation parameters for a tolling deal are conversion rate and the fixed fee for tolling. All other deal parameters are not negotiable.

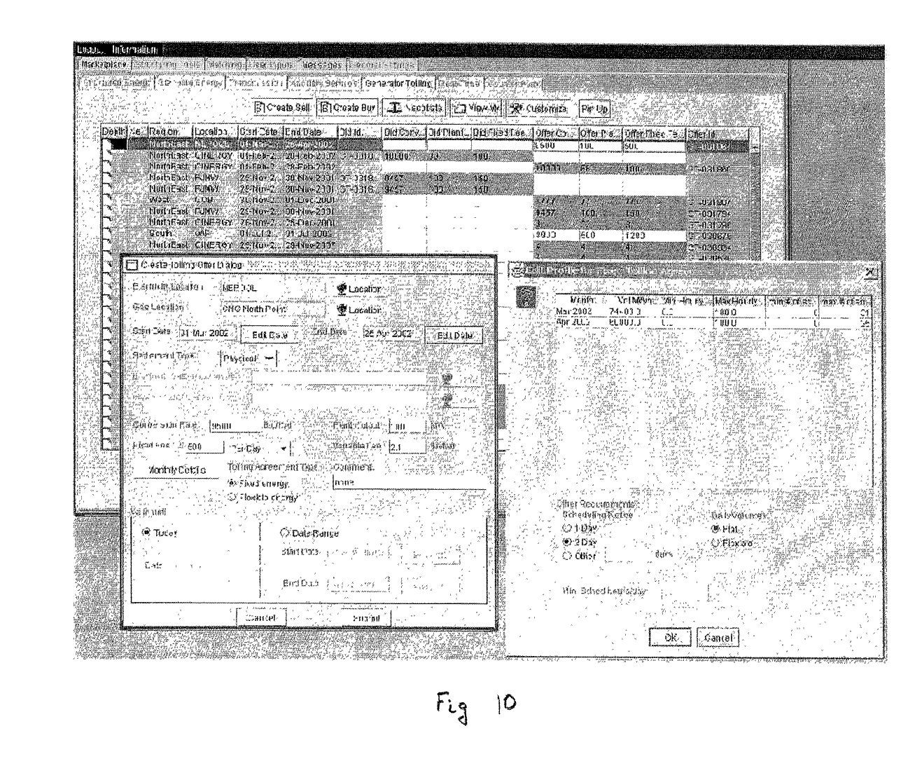

With respect to FIG. 10, the following is a description of a tolling transaction. The fields displayed for generator tolling arrangements are conversion rate, plant o/p, fixed tolling fee ($) and variable tolling fee ($/Mwh). The conversion rate is the heat rate specified for the transaction in Btu/KWh, plant o/p is the generator guaranteed output in MW, and the fixed fee is the fee paid to the generator in dollars per day, month, or year. As with other transaction types, the details can be seen by right clicking on the mouse and selecting details. The details will show whether the deal is for fixed or flexible energy, the fee frequency (per day, month or year), plus other details. A button at the bottom of the detail menu called “View Profile” will show additional features of the transaction such as: minimum and maximum monthly and daily takes, utilization factors, and generator availability factors.

The following is a description of an exemplary tolling transaction. The user wishes to offer a tolling arrangement for gas to be delivered at Appalachia, CNG North Point, and electricity provided into NEPOOL. Additional details are shown below.

1. In the main window, the user clicks on the Marketplace tab and within Marketplace, clicks the Generator Tolling tab.

2. To create an offer, the client clicks on the “Create Sell” button or similarly, bids are created by clicking the “Create Buy” button.

3. Northeast for region and NEPOOL for location are selected here.

4. The user selects a start date of Mar. 1, 2002 and an end date of Apr. 25, 2002.

5. Conversion rate or heat rate is entered. In this example, the heat rate is 9,500 Btu/KWh for the transaction period.

6. Fixed fee of $500 per day is entered, and a variable fee of $2.10/Mwh is entered.

7. In the “Plant Output” field, size is entered. In this example, it is 100 MW.

8. The user now clicks on the “Monthly Details” button. Here, the load for each month and the guaranteed availability factor for each month are specified. The default values for each month is the specified plant output size (which is the maximum that can be used) and also a guaranteed availability factor of 100% (which can also be onl downward adjusted). At the bottom of the dialog box, users select any relevant nonperformance penalties listed as A, B, C, D, and E. These penalties represent specific financial obligations by the generator for nonperformance, including how nonperformance is settled between the parties. These nonperformance penalties are defined in the system, accessible through the Documentation option.

9. The user then selects a “Tolling Agreement Type,” either fixed or flexible energy. The difference between fixed and flexible energy is that for fixed energy, the energy taken must be for the specified amount. If flexible energy is selected, the energy take in a given month can vary between the specified minimum and maximum values.

If the user selects fixed energy agreement type, the software application of the present invention utilizes the fixed energy transaction template.

In the fixed energy transaction template the “Vol MWh” column, the fixed monthly volume in MWh is specified. Here, the default value is 74,400 for March 2002 and 60,000 for April 2002. These values represent the maximum volumes given the date range and plant size constraints, and are calculated and displayed for the user. Again, these values can only be downward adjusted. In the “Min Hourly” column, the user specifies the minimum energy in MW to be delivered in any hour when there are deliveries. In the “Max Hourly” column, the user specifies maximum energy in MW to be delivered in any hour. The maximum energy amount cannot exceed the MW amount specified for “Plant Output”, and of course the minimum must be less than or equal to the maximum value.

The minimum and the maximum number of days generation can be scheduled for a given month is specified here. This reflects one dimension of operating flexibility for delivering energy.

The minimum number of hours in a day that the generation can be scheduled is also specified here. This reflects a second dimension of operating flexibility for delivering energy.

If the user selects flexible energy agreement type, the software application of the present invention utilizes the flexible energy transaction template.

This template is very similar to the fixed energy template. However, the energy volume delivered for the entire month can vary between specified minimum and maximum volumes.

The default values will be zero for minimum volumes and the (total # of possible days per month)×(24 hours per day)×(monthly MW volume) as the maximum volume. This reflects the feasible range of values that the user can specify. The minimum monthly volume ends up being: (minimum number of scheduling days)×(minimum size)×(minimum number of scheduled hours/day).

As the user fills in the details of the profile for flexible energy, the application will check for overall feasibility of values when the user submits the values. If the combination of values entered are infeasible, a message will appear stating which values are infeasible.

1. As is the case with any transaction utilizing the present invention, the “Valid until” section at the bottom of the screen is used to define the period for which the counterparties can either buy/sell the posted product, or initiate a negotiation process. The choices are today only, or a user defined “Date From” and “Date To” range.

2. Bids are posted to the marketplace by clicking the submit button.

Negotiations

Users can initiate a negotiation with the originator of any posted transaction. This activity is generally conducted through the Marketplace tab of the application, although negotiation sessions may be launched directly from matching results (and the Matching tab). For all standard products, Standard Energy, Transmission, Real Time Energy and Ancillaries, both price and size of a transaction are negotiable. For Generator Tolling products, the negotiable parameters are the fixed fee, variable fee and the conversion rate. For Structured Energy Products, users may be able to negotiate on several parameters of the transaction other than simply weighted average price and total volume. If the negotiation is considered flexible, then start/end dates and the hourly shapes for prices and volumes are also negotiable. For option transactions, the same parameters as the underlying products are negotiable, but in addition also the option premium.

There are no default time limits to a negotiation process other than the start date of the transaction. A negotiation is possible at any time so long as the transaction remains open in the marketplace and neither party has rejected a negotiation session. It is also possible that the user submitting accepted values during a negotiation will set a negotiation time limit after which the status would by default change from accept status to open. This time limit is specified in hours and is calibrated to a single server time (prevailing east coast time). The terms of the negotiation are not binding unless both parties click on the “Accept” button. At any time, users can terminate a negotiation process by clicking the “Reject” button. Once a negotiation session is rejected, the session is gone but a new template can be processed.

After the first party has clicked the “Accept” button the terms of the transaction are not binding until the second party also clicks on the “Accept” button. At any time before the second party clicks on the accept button, the first party can modify its submission by reentering new values and clicking “Submit” again. If a party creates new values and immediately hits the “Accept” button, that is equivalent to performing two actions in sequence, submitting updated values and then immediately accepting those values. Therefore, the only way a negotiated transaction is executed in the system is if both parties hit the “Accept” button for the same values in the “Current Value” field.

Anytime a user initiates a negotiation, the originator of the transaction will be notified in several ways. First, their “Messages” tab will alert them to the fact that they have messages, and also the type of message they are receiving. Second, if users go to a particular marketplace, they will easily be able to view those transactions for which other market participants have sought negotiations. For a particular transaction, an icon will appear in the negotiations field. Messaging continues throughout a negotiation process as updated values are submitted. Once in the negotiation dialog, users can view any of their active negotiation sessions by scrolling down the list of transactions.

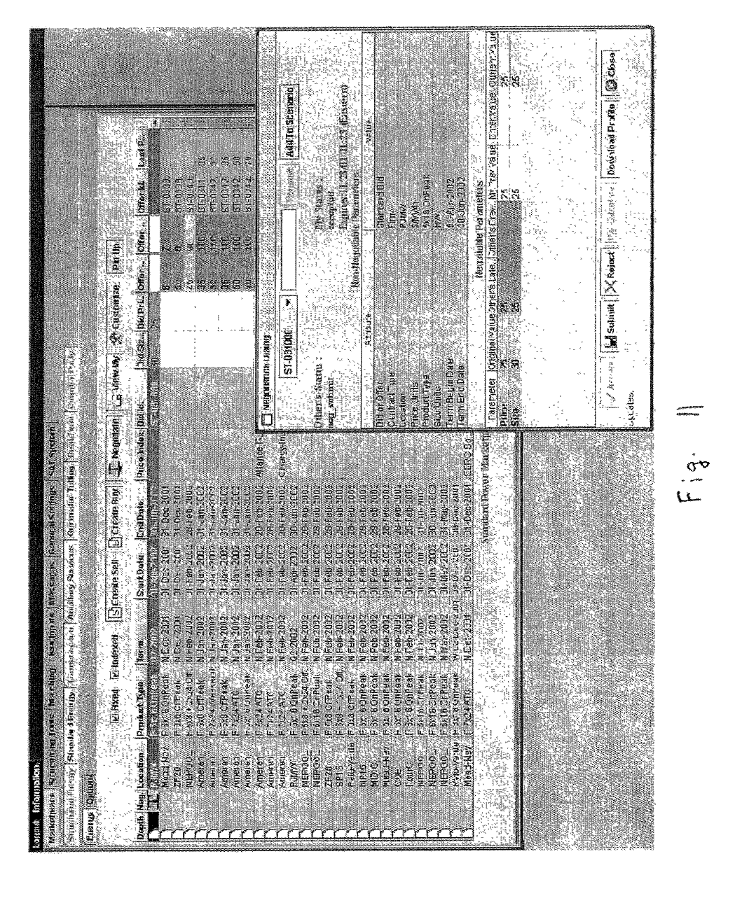

With respect to FIG. 11, the following is a description of an exemplary basic negotiation. A user wants to sell a Peak, fixed priced, physically settled deal at PJMW for second quarter 2002 at a price of $25/MWh and a size of 20 MW. There is a posting in the Standard Energy Market that nearly matches this requirement except that the size of the bid is 30 MW. A user wishes to initiate a negotiation with the originator of the bid.

1. On the main window, the user clicks on the Marketplace tab and within the market, clicks on the Standard Energy tab.

2. To initiate a negotiation, the row containing the specific bid is highlighted and then the “Negotiate” button is clicked.

3. Note the layout of the negotiations dialog box that pops up. The first drop down box on the upper left labels the negotiation by transaction ID number. By scrolling down, users will see all active negotiation sessions for all transaction types (Energy, Transmission, Options, Ancillaries and Generator Tolling). The text box to the right of the negotiation ID number allows users to rename the negotiation. To rename the negotiation, type a new name click on the rename button.

4. When first initiating a negotiation, both “Your Status” and the “Other's Status” are new. As negotiations progress, the status will reflect the last action taken by each of the parties. For example, if a user submits updated values, “Your Status” will change to “neg submit”, where “neg.” stands for negotiations. The status provides a means of keeping track of the last action taken by each of the negotiating parties. In this illustration, the user elects to reduce the transaction size from 30 MW to 20 MW. The user enters 20 in size field of the “Enter Value” column and clicks enter followed by the submit button. Upon submitting, the values in the Enter value field move over to the “Current Value” field, as they represent the current bid/offer in the negotiation process. If and when a transaction is executed, the values are according to those values in the Current value field. In the “Negotiable Parameters” section, the “Original Value” field displays the values consistent with the transaction posted on the market by the deal originator.

The “Latest Value” field displays the most recent value submitted by the other party. “Prev Value” field displays the second most recent value submitted by the other party. “My Prev Val” field displays the previous value you submitted. “Enter Value” is where a user enters values to submit to the other party.

In this example, the updated Negotiations screen displays a value of 25 MW as current and as the latest value submitted by the other party. The user can either counter the proposal by entering a new value, can accept the proposed values, or can even reject the negotiation session. Here the user has elected to accept the current values proposed by the other party.

The other party can then also accept the terms of the transaction, enter new values and submit them or even reject the negotiation session. Only when both parties accept is the transaction considered executed. At that point notification e-mails and faxes of the transaction are sent to both parties.

The process of Basic negotiations is same for all standard products, including Real Time Power, Ancillary Services, and Transmission, where the price and size are negotiable.

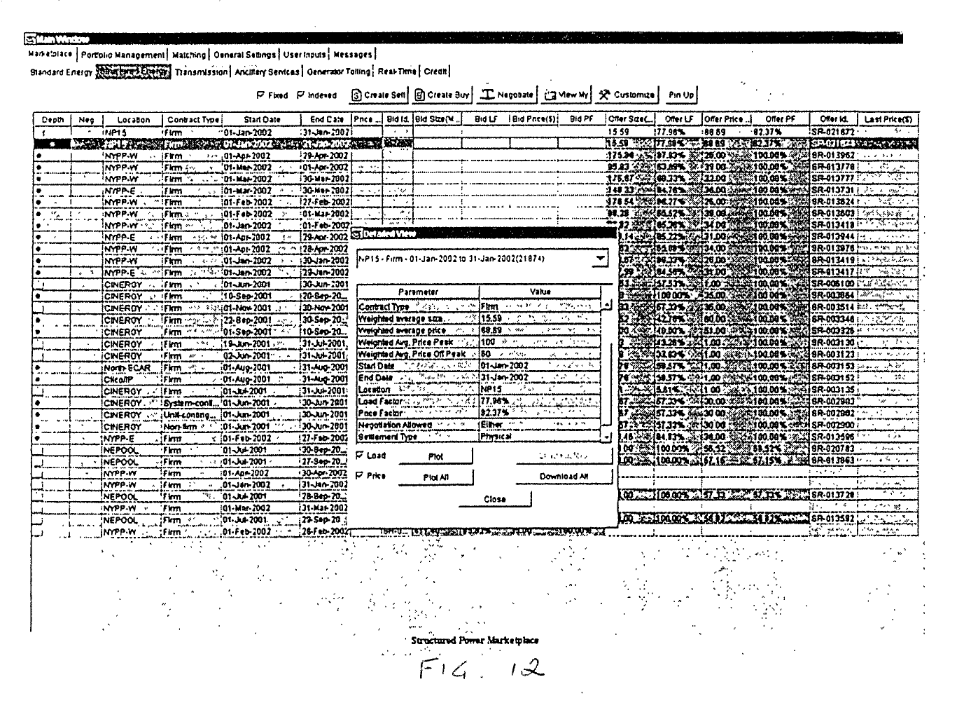

Flexible negotiations are possible for structured energy and option transactions, where the deal originator has specified at the time of creating that transaction that it is willing to consider a flexible negotiation process. With respect to FIG. 12, the following is a description of an exemplary flexible negotiation.

Here, a user is interested in purchasing a shaped product for NP15. The user wants 10MW off-peak and 30 MW peak for the months of January and February 2002. The user is willing to pay up to $60/MWh for off-peak and up to $100/MWh for peak. The user notices an offer in the Structured Energy Marketplace for NP15 product with weighted average size of 15.59 MW, load factor of 77.96%, and weighted average price of 88.69 for the month of January 2002. To learn more about the details of the offer, the user selects the row of the transaction and right clicks on details (see viewing details under structured energy transactions). The user notices that offer is 10 MW off-peak at a price of $60/MWh and 20 MW peak at a price of $100/MWh.

The user also notices that the originator of the deal has selected “Either” for “Negotiation Allowed.” In other words, the originator of the deal is willing to engage in either a “Flexible” or a “Basic” negotiation. In a basic negotiation for structured energy, only the weighted average size and the weighted average price can be negotiated. In a flexible negotiation process, in addition to weighted average price and size, several other parameters can also be negotiated. Since the user in this example is interested in negotiating the duration in addition to price and size, the user elects to initiate a flexible negotiation.

1. The row of the transaction is highlighted and the negotiate button is clicked.

2. Because the originator of the deal is willing to engage in either flexible or basic negotiation, a dialog prompts the user to select the type of negotiation. Since the user wants flexible negotiation, that option is selected.

For flexible negotiation, the additional negotiation parameters are volume and price shapes, and the transaction start and the end dates. To change any of these parameters, a user clicks on any one of those cells in the “Enter Value” field. A dialog box similar to the one used to create the original structured transaction then appears. If the user chooses to just change the weighted average price and/or total volume, the changes entered in the “Enter Value” field will simply scale (same percentage increase for all hours) the original transaction's price and volume patterns respectively. By simply scaling the transaction, the integrity of the original shapes for price and volume are maintained.

3.—The desired changes are made. In this example, the end date has been changed to Feb. 28; 2002, the on-peak size is changed to 30 MW and the price is changed to $95/MWh. To apply the changes in load and price shapes the “Apply” button is clicked and the values are submitted into the negotiations dialog session using the “submit” button. The “Enter Values” field is updated with these new values. To submit the offer to the other party, the user clicks on the “Submit” button at the bottom of the negotiation dialog box. Note: At any time, users can hit the “Recalculate” button to view some of the major statistics of the transaction, based on values contained in the “Enter Values” field. The “Recalculate” button can be used to examine changes in stand-alone risk and values of the transaction. The system performs the necessary volume and price shape calculations, and also VaR calculations on the fly so that the recalculated values are always current with values that either would be or have been submitted.

4. Here, the other party accepts the changes except for the peak price, which is changed to $98/MWh from your offer of $95/MWh. At this point the user can either accept the current values, counter the offer or reject the entire negotiation.

The current load and price details of the counteroffer can be downloaded to Microsoft Excel. This is identical to the Excel upload/download functionality available when creating new transactions. To gain access to that feature, the user first must have clicked on either the start/end date or volume/price shape cells in the “Enter Value” field. At that point, the user would hit the “Hourly Details” Profile” button, the same process as in creating a new transaction. When selected, a dialog box asks if you want to download existing profile. To get the data click “Yes.”

There is no limit to the amount of time or number of counterbids/offers that can take place during a negotiation, subject only to the date and user specified time windows for negotiating. Active negotiation sessions remain unless the transaction is executed, the negotiation process expires, or a party rejects the negotiation session.

In addition to the exemplary transactions described above, the present invention can be utilized to for trading commodity and other financial products having established and developed markets. Other uses and modifications to the present invention will be obvious to those skilled in the art. The techniques described here are not limited to any particular hardware or software configuration; they may find applicability in any computing or processing environment. For example, functions described as being performed by a server can be distributed across different platforms. Moreover, the techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Thus, the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A utility resource transaction and management method accessible by a plurality of users over a computer network comprising:
defining a database in a host computer having a processor and an interface device,
storing in said database information pertaining to a plurality of utility resources;
providing at least one customer with access to said database information pertaining to a plurality of utility resources;
receiving into said host computer information pertaining to an exchange of said utility resources from at least one consumer;
calculating a plurality of exchange constraints based upon said information pertaining to an exchange of said utility resources;
establishing an exchange correspondence between said at least one consumer and said utility resource based upon at least one exchange constraint; and
providing an computer accessible exchange report.

2. The utility resource transaction and management method of claim 1 wherein said utility resource comprises electrical power.

3. The utility resource transaction and management method of claim 1, wherein said utility resource comprises natural gas.

4. The utility resource transaction and management method of claim 1 wherein said utility resource comprises water.

5. The utility resource transaction and management method of claim 1, wherein said utility resource comprises sewer services.

6. The utility resource transaction and management method of claim 1, wherein said computer network comprises a WAN.

7. The utility resource transaction and management method of claim 1, wherein said WAN is the Internet.

8. The utility resource transaction and management method of claim 1, wherein said receiving into said host computer information pertaining to an exchange of said utility resources comprises receiving information pertaining to a plurality of variables concerning said utility resources.

9. The utility resource transaction and management method of claim 8, wherein said variables concerning said utility resources comprises resource cost.

10. The utility resource transaction and management method of claim 8, wherein said variables concerning said utility resources comprises resource quantity.

11. The utility resource transaction and management method of claim 8, wherein said variables concerning said utility resources comprises resource quantity and cost.

12. The utility resource transaction and management method of claim 1, wherein said exchange constraint comprises a cost variable.

13. The utility resource transaction and management method of claim 1, wherein said exchange constraint comp rises a quantity.

14. The utility resource transaction and management method of claim 1, wherein said providing an computer accessible exchange report comprises providing said computer-viewable data through a GUI.

15. The utility resource transaction and management method of claim 14, wherein said GUI comprises a plurality of variable user defined display reports.

16. The utility resource transaction and management method of claim 14, wherein said GUI comprises a plurality of variable user defined display reports of importance to a particular customer.
